(19) United States
(12) Patent Application Publication
(10) Pub. No.: US 2006/0025998 A1
(43) Pub. Date: Feb. 2, 2006

(54) Information-processing apparatus, information-processing methods, recording mediums, and programs

(75) Inventors: Yusuke Sakai, Kanagawa (JP); Naoki Saito, Kanagawa (JP); Mikio Kamada, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/177,444

(22) Filed: Jul. 11, 2005

(30) Foreign Application Priority Data
Jul. 27, 2004 (JP) 2004-218531

(51) Int. Cl. G10L 13/08

(52) U.S. Cl. 704/260

(57) ABSTRACT

The present invention provides an information-processing apparatus for communicating with an other information-processing apparatus, which is connected to the information-processing apparatus through a network. The apparatus includes reproduction means for synchronously reproducing content data common to the other apparatus, user-information receiver means for receiving a voice and image of an other user from the other apparatus, synthesis means for synthesizing a voice and image of the content data synchronously reproduced by the reproduction means with a voice and image received by the user-information receiver means as the voice and image of the other user, characteristic analysis means for analyzing at least one of a voice of the content synchronously reproduced by the reproduction means, an image of the content data, and auxiliary information added to the content data in order to recognize a characteristic of the content data, and parameter-setting means for setting a control parameter to be used for controlling a process, which is carried out by the synthesis means to synthesize voices and images, on the basis of an analysis result produced by the characteristic analysis means.

### CROSS REFERENCES TO RELATED APPLICATIONS

The present invention contains subject matter related to Japanese Patent Application JP 2004-218531 filed in the Japanese Patent Office on Jul. 27, 2004, the entire contents of which being incorporated herein by reference.

### BACKGROUND OF THE INVENTION

The present invention relates to an information-processing apparatus, an information-processing method, a recording medium, and a program. More particularly, the present invention relates to an information-processing apparatus, an information-processing method, a program, and a recording medium, which are connected to the other apparatus each other by a network, used for synthesizing a content common to the apparatus with voices and images of users operating the apparatus and used for reproducing a synthesis result synchronously.

The apparatus in related art used in interactions with people at locations remotely separated from each other include the telephone, the so-called TV telephone, and a video conference system. There is also a method whereby personal computers or the like are connected to the Internet and used for chats based on texts and video chats based on images and voices. Such interactions are referred to hereafter as remote communications.

In addition, there has also been proposed a system wherein people each carrying out remote communications with each other share a virtual space and the same contents through the Internet by using personal computers or the like connected to the Internet. For more information on such a system, refer to documents such as Japanese Patent Laid-open No. 2003-271530.

### SUMMARY OF THE INVENTION

In the method in related art allowing users at locations remotely separated from each other to share the same content, however, the users communicate with each other by transmission of mainly information written in a language. Thus, the method in related art has a problem of difficulties to express the mind and situation of a user to another user in comparison with the face-to-face communication in which the user is actually facing the communication partner.

In addition, the method in related art wherein the user can view an image of the communication partner and listen to a voice of the partner along with the same content shared with the partner has a problem of difficulties to operate the apparatus in order to optimally synthesize the image and voice of the partner with the image and sound of the content by manual operations or the like, which are carried out by the user, due to complexity of the apparatus.

Addressing the problems described above, inventors of the present invention have devised a technique capable of setting a synthesis of a plurality of images and a plurality of sounds with ease in accordance with the conditions of users present at locations remote from each other in a process carried out by the users to view and listen to the same content.

According to an embodiment of the present invention, there is provided an information-processing apparatus including:
reproduction means for reproducing content data common to the information-processing apparatus and an other information-processing apparatus synchronously with the other information-processing apparatus;
user-information receiver means for receiving a voice and image of an other user from the other information-processing apparatus;
synthesis means for synthesizing a voice and image of the content data synchronously reproduced by the reproduction means with a voice and image received by the user-information receiver means as the voice and image of the other user;
characteristic analysis means for analyzing at least one of a voice of the content data synchronously reproduced by the reproduction means, an image of the content data, and auxiliary information added to the content data in order to recognize a characteristic of the content data; and
parameter-setting means for setting a control parameter to be used for controlling a process, which is carried out by the synthesis means to synthesize voices and images, on the basis of an analysis result produced by the characteristic analysis means.

In accordance with an embodiment of the present invention, it is also possible to provide a configuration in which the characteristic analysis means carries out the analysis in order to recognize a characteristic of a scene included in content data and the parameter-setting means sets a control parameter to be used for controlling a process, which is carried out by the synthesis means to synthesize voices and images, on the basis of the scene characteristic recognized as an analysis result produced by the characteristic analysis means.

In accordance with another embodiment of the present invention, it is also possible to provide a configuration in which the characteristic analysis means carries out the analysis in order to recognize the position of character information on an image included in content data as a characteristic of the image and the parameter-setting means sets a control parameter to be used for controlling a process, which is carried out by the synthesis means to synthesize voices and images, on the basis of the position of the character information on the image as an analysis result produced by the characteristic analysis means.

In accordance with a further embodiment of the present invention, it is also possible to provide a configuration in which the parameter-setting means also sets a control parameter of an other information-processing apparatus on the basis of an analysis result produced by the characteristic analysis means, and sender means transmits the control parameter set by the parameter-setting means to the other information-processing apparatus.

According to an embodiment of the present invention, there is provided an information-processing method including the steps of:
reproducing content data common to an information-processing apparatus and an other information-processing apparatus synchronously with the other information-processing apparatus;
receiving a voice and image of an other user from the other information-processing apparatus;
synthesizing a voice and image of the content data synchronously reproduced in a process carried out at the reproduction step with a voice and image received in a process carried out at the user-information receiver step as the voice and image of the other user;
analyzing at least one of a voice of the content data synchronously reproduced in a process carried out at the reproduction step, an image of the content data, and auxiliary information added to the content data in order to recognize a characteristic of the content data; and
setting a control parameter to be used for controlling a process, which is carried out at the synthesis step to synthesize voices and images, on the basis of an analysis result produced in a process carried out at the characteristic analysis step.

According to an embodiment of the present invention, there is provided a recording medium for recording a program, the program including the steps of:
reproducing content data common to a computer and an information-processing apparatus synchronously with the information-processing apparatus;
receiving a voice and image of an other user from the information-processing apparatus;
synthesizing a voice and image of the content data synchronously reproduced in a process carried out at the reproduction step with a voice and image received in a process carried out at the user-information receiver step as the voice and image of the other user;
analyzing at least one of a voice of the content data synchronously reproduced in a process carried out at the reproduction step, an image of the content data, and auxiliary information added to the content data in order to recognize a characteristic of the content data; and
setting a control parameter to be used for controlling a process, which is carried out at the synthesis step to synthesize voices and images, on the basis of an analysis result produced in a process carried out at the characteristic analysis step.

According to an embodiment of the present invention, there is provided a program including the steps of:
reproducing content data common to a computer and an information-processing apparatus synchronously with the information-processing apparatus;
receiving a voice and image of an other user from the information-processing apparatus;
synthesizing a voice and image of the content data synchronously reproduced in a process carried out at the reproduction step with a voice and image received in a process carried out at the user-information receiver step as the voice and image of the other user;
analyzing at least one of a voice of the content data synchronously reproduced in a process carried out at the reproduction step, an image of the content data, and auxiliary information added to the content data in order to recognize a characteristic of the content data; and
setting a control parameter to be used for controlling a process, which is carried out at the synthesis step to synthesize voices and images, on the basis of an analysis result produced in a process carried out at the characteristic analysis step.

According to an embodiment of the present invention, there is provided an information-processing apparatus including:
a reproduction section for reproducing content data common to the information-processing apparatus and the other information-processing apparatus synchronously with the other information-processing apparatus;
a user-information receiver section for receiving a voice and image of an other user from the other information-processing apparatus;
a synthesis section for synthesizing a voice and image of the content data synchronously reproduced by the content reproduction section with a voice and image received by the user-information receiver section as the voice and image of the other user;
an characteristic analysis section for analyzing at least one of a voice of the content data synchronously reproduced by the reproduction section, an image of the content data, and auxiliary information added to the content data in order to recognize a characteristic of the content data; and
a parameter-setting section for setting a control parameter to be used for controlling a process, which is carried out by the synthesis section to synthesize voices and images, on the basis of an analysis result produced by the characteristic analysis section.

As described above, in an embodiment of present invention, a content common to an information-processing apparatus and another information-processing apparatus is reproduced in the information-processing apparatus synchronously with the other information-processing apparatus. A voice and image of another user are received from the other information-processing apparatus operated by the other user. Then, a voice and image of the synchronously reproduced content are synthesized with respectively a voice and image received from the other user. In addition, one of a voice of the synchronously reproduced content, an image of the content, and auxiliary information added to the content is analyzed in order to recognize a characteristic of the content. Then, a control parameter to be used for controlling a process carried out to synthesize voices and images is set on the basis of the analysis result.

A network is a mechanism for connecting at least two apparatus to each other and propagating information from one apparatus to another. Apparatus communicating with each other through the network can be independent apparatus or internal blocks included in one apparatus.

Communication can be radio or wire communication. As an alternative, communication can also be a combination of the radio communication and the wire communication, which are mixed with each other. That is to say, the radio communication is adopted for certain operation areas while the wire communication is carried out for other areas. As an alternative, the radio communication and the wire communication are mixed with each other by applying the radio communication to communications from a certain apparatus to another apparatus but applying the wire communication to communications from the other apparatus to the certain apparatus.

In accordance with an embodiment of the present invention, a synthesis of a plurality of images and a plurality of voices can be set with ease in accordance with a content being reproduced. In addition, users present at locations remote from each other are capable of communicating with each other in a lively manner.

### BRIEF DESCRIPTION OF THE DRAWINGS

These and other objects of the present invention will be seen by reference to the following description, taken in connection with the accompanying drawings, in which:

FIG. 1 is a diagram showing a typical configuration of a communication system according to an embodiment of the present invention;

FIGS. 2A to 2C are diagrams showing a typical image of a content and typical images of users in the communication system shown in FIG. 1;

FIGS. 3A to 3C are diagrams showing typical patterns of synthesis of a content image with user images;

FIG. 4 is a block diagram showing a typical configuration of a communication apparatus 1-1 employed in the communication system shown in FIG. 1;

FIG. 5 shows a flowchart referred to in an explanation of remote communication processing carried out by the communication apparatus shown in FIG. 4;

FIG. 6 is a block diagram showing a detailed typical configuration of a data analysis section employed in the communication apparatus shown in FIG. 4;

FIG. 7 is a diagram referred to in explanation of a typical characteristic analysis mixing process carried out in accordance with a scene of a content;

FIG. 8 is a diagram referred to in explanation of a typical characteristic analysis mixing process carried out in accordance with the type of a content;

FIG. 9 shows a flowchart referred to in explanation of a content-characteristic analysis mixing process carried out at a step S5 of the flowchart shown in FIG. 5;

FIG. 10 shows a flowchart referred to in explanation of a content analysis process carried out at a step S22 of the flowchart shown in FIG. 9;

FIG. 11 shows a flowchart referred to in explanation of another implementation of the content analysis process carried out at the step S22 of the flowchart shown in FIG. 9;

FIG. 12 shows a flowchart referred to in explanation of a control-information receiver process carried out at a step S24 of the flowchart shown in FIG. 9; and

FIG. 13 is a block diagram showing a typical configuration of a personal computer according to an embodiment of the present invention.

### DETAILED DESCRIPTION OF THE PREFERRED EMBODIMENTS

Before preferred embodiments of the present invention are explained, relations between disclosed inventions and the embodiments are explained in the following comparative description. It is to be noted that, even if there is an embodiment described in this specification but not included in the following comparative description as an embodiment corresponding to an invention, such an embodiment is not to be interpreted as an embodiment not corresponding to an invention. Conversely, an embodiment included in the following comparative description as an embodiment corresponding to a specific invention is not to be interpreted as an embodiment not corresponding to an invention other than the specific invention.

In addition, the following comparative description is not to be interpreted as a comprehensive description covering all inventions disclosed in this specification. In other words, the following comparative description by no means denies existence of inventions disclosed in this specification but not included in claims as inventions for which a patent application is filed. That is to say, the following comparative description by no means denies existence of inventions to be included in a separate application for a patent, included in an amendment to this specification, or added in the future.

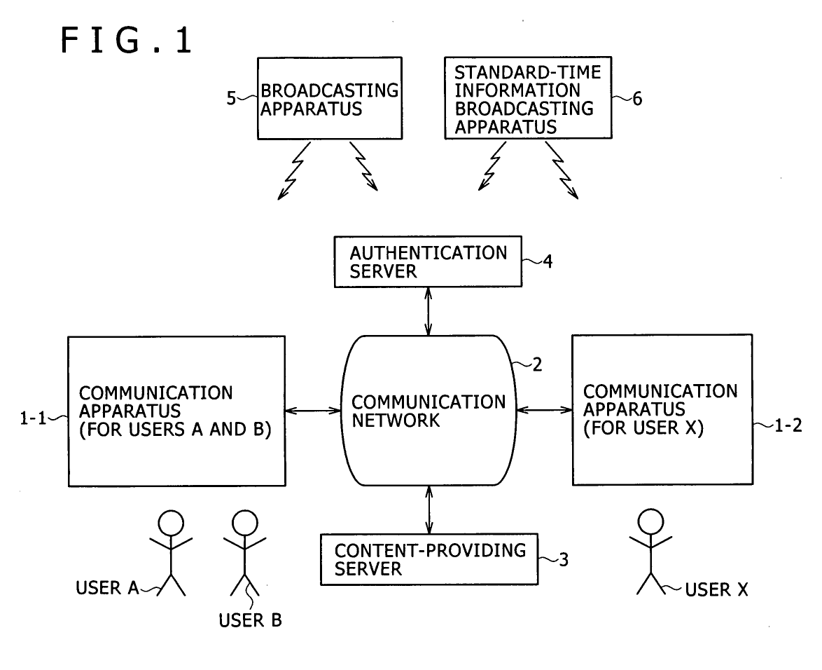

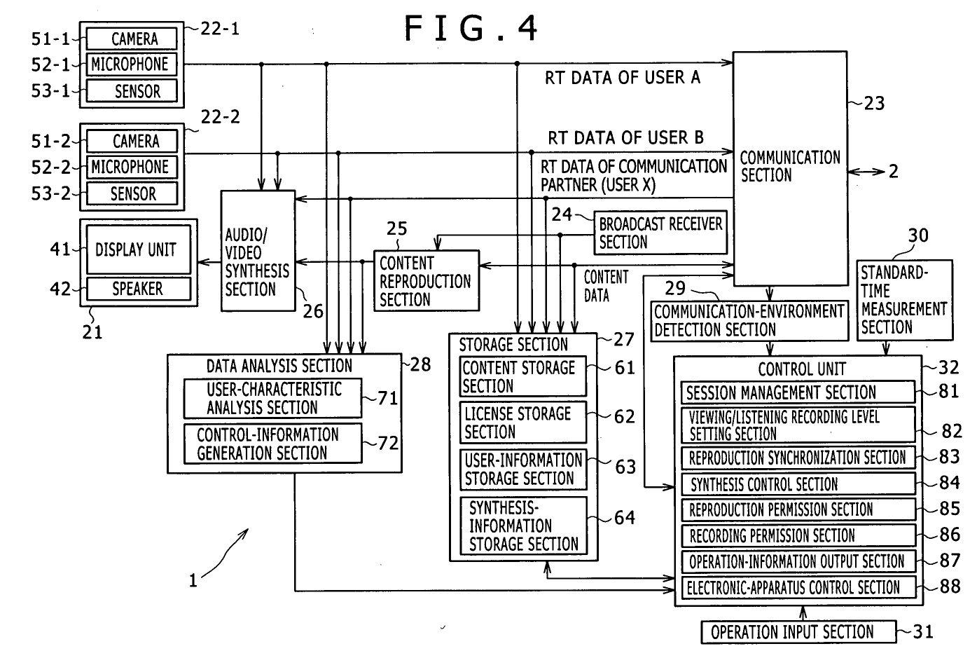

An information-processing apparatus (such as a communication apparatus 1-1 as shown in FIG. 1) according to an embodiment of the present invention includes:
reproduction means (such as a content reproduction section 25 as shown in FIG. 4) for reproducing content data common to this information-processing apparatus and an other information-processing apparatus (such as a communication apparatus 1-2 shown in FIG. 1) synchronously with the other information-processing apparatus;
user-information receiver means (such as a communication section 23 as shown in FIG. 4) for receiving a voice and image of an other user from the other information-processing apparatus;
synthesis means (such as an audio/video synthesis section 26 as shown in FIG. 4) for synthesizing a voice and image of the content data synchronously reproduced by the reproduction means with a voice and image received by the user-information receiver means as the voice and image of the other user;
characteristic analysis means (such as a content-characteristic analysis section 71 as shown in FIG. 4) for analyzing at least one of a voice of the content data synchronously reproduced by the reproduction means, an image of the content data, and auxiliary information added to the content data in order to recognize a characteristic of the content data; and
parameter-setting means (such as a control-information generation section 72 as shown in FIG. 4) for setting a control parameter to be used for controlling a process, which is carried out by the synthesis means to synthesize voices and images, on the basis of an analysis result produced by the characteristic analysis means.

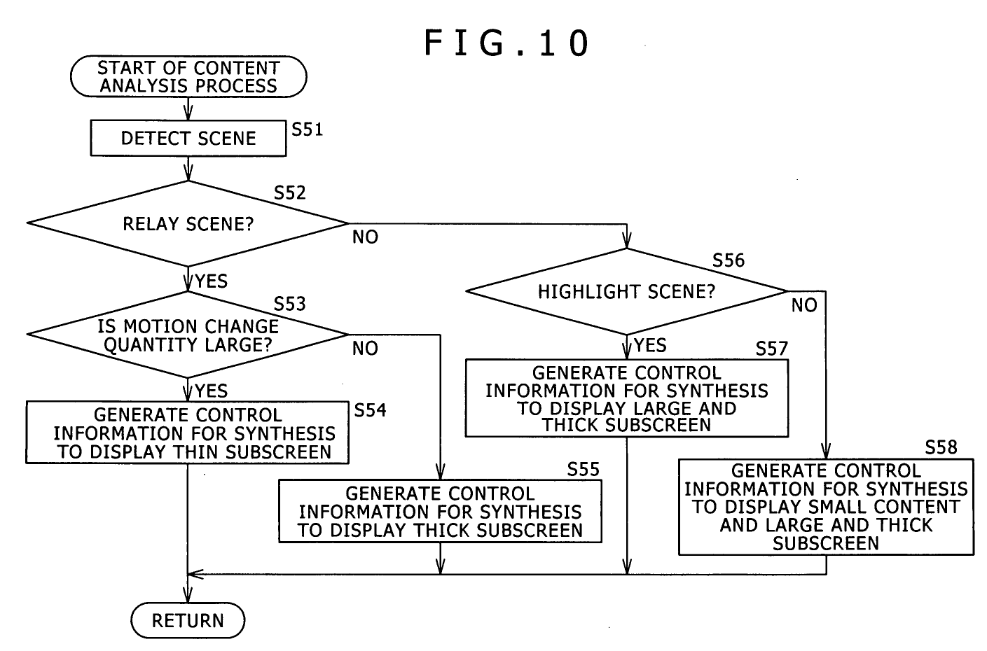

In accordance with an embodiment of the present invention, it is also possible to implement the information-processing apparatus into a configuration that the characteristic analysis means (such as the content-characteristic analysis section 71 as shown in FIG. 4 for performing a process at a step S51 of a flowchart shown in FIG. 10) carries out the analysis in order to recognize a characteristic of a scene included in content data and the parameter-setting means (such as the control-information generation section 72 as shown in FIG. 4 for performing a process at a step S57 of the flowchart shown in FIG. 10) sets a control parameter to be used for controlling a process, which is carried out by the synthesis means to synthesize voices and images, on the basis of the scene characteristic recognized as an analysis result produced by the characteristic analysis means.

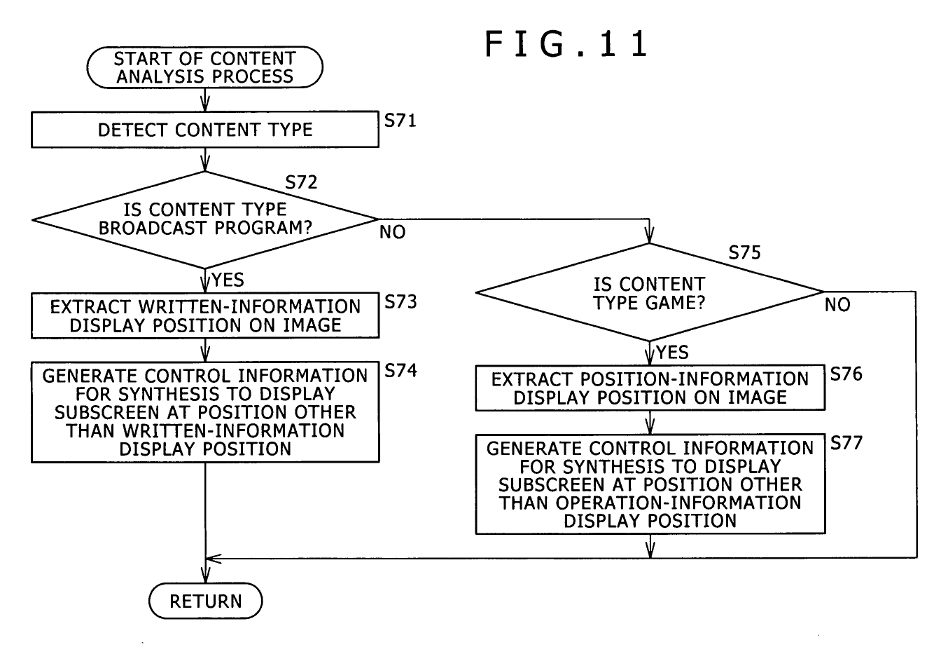

In accordance with another embodiment of the present invention, it is also possible to possible to implement the information-processing apparatus into a configuration that the characteristic analysis means (such as the content-characteristic analysis section 71 as shown in FIG. 4 for performing a process at a step S73 of a flowchart shown in FIG. 11) carries out the analysis in order to recognize the position of a character information on an image included in content data as a characteristic of the image and the parameter-setting means (such as the control-information generation section 72 as shown in FIG. 4 for performing a process at a step S74 of the flowchart shown in FIG. 11) sets a control parameter to be used for controlling a process, which is carried out by the synthesis means to synthesize voices and images, on the basis of the position of the character information on the image as an analysis result produced by the characteristic analysis means.

In accordance with a further embodiment of the present invention, it is also possible to possible to implement the information-processing apparatus into a configuration that the parameter-setting means also sets a control parameter of an other information-processing apparatus on the basis of an analysis result produced by the characteristic analysis means and sender means (such as a operation-information output section 87 as shown in FIG. 4) transmits the control parameter set by the parameter-setting means to the other information-processing apparatus.

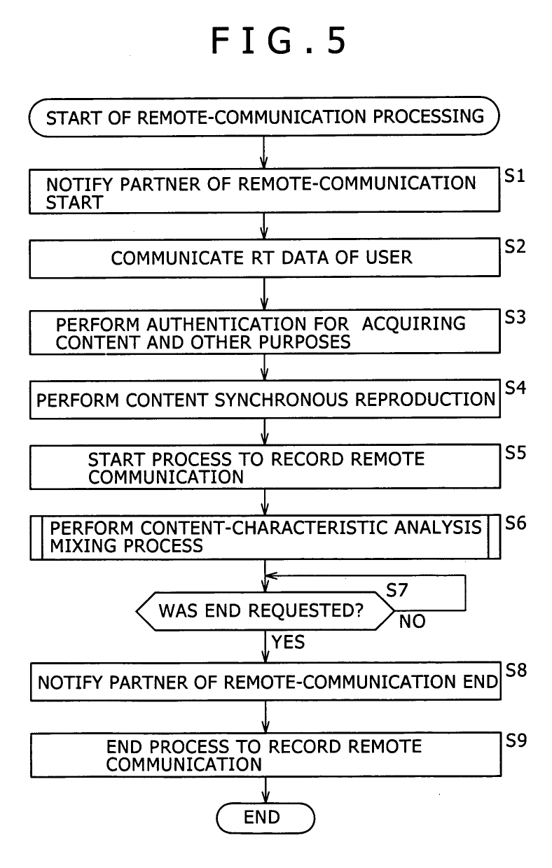

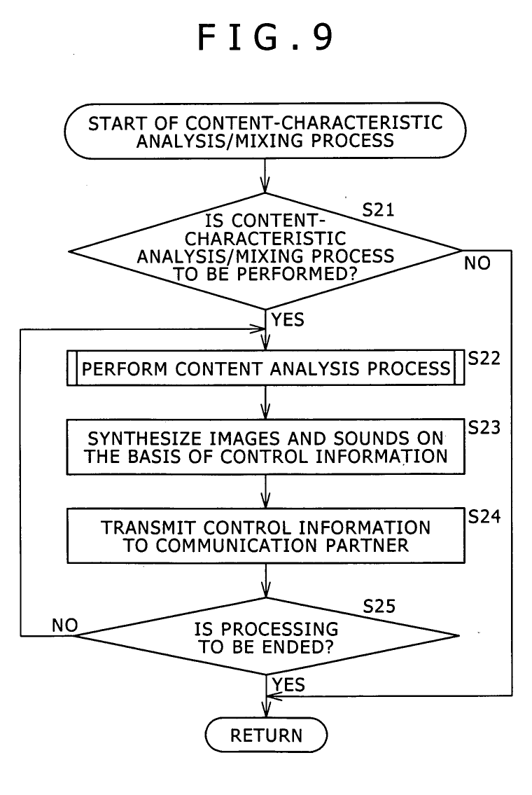

According to an embodiment of the present invention, there is provided an information-processing method including the steps of:
reproducing content data common to an information-processing apparatus and an other information-processing apparatus synchronously with the other information-processing apparatus (such as a step S4 of a flowchart shown in FIG. 5);
receiving a voice and image of an other user from the other information-processing apparatus (such as a step S2 of the flowchart shown in FIG. 5);
synthesizing a voice and image of the content data synchronously reproduced in a process carried out at the reproduction step with a voice and image received in a process carried out at the user-information receiver step as the voice and image of the other user (such as a step S23 of the flowchart shown in FIG. 9);
analyzing at least one of a voice of the content data synchronously reproduced in a process carried out at the reproduction step, an image of the content data, and auxiliary information added to the content data in order to recognize a characteristic of the content data (such as a step S51 of the flowchart shown in FIG. 10); and
setting a control parameter to be used for controlling a process, which is carried out at the synthesis step to synthesize voices and images, on the basis of an analysis result produced in a process carried out at the characteristic analysis step (such as a step S57 of the flowchart shown in FIG. 10).

It is to be noted that relations between a recording medium and a concrete implementation of the present invention are the same as the relations described above as relations between the information-processing method and a concrete implementation of the present invention. By the same token, relations between a program and a concrete implementation of the present invention are the same as the relations described above as relations between the information-processing method and a concrete implementation of the present invention. Thus, the relations between the recording mediums and the concrete implementation as well as the relations between the program and the concrete implementation of the present invention are not explained to avoid duplications.

The embodiments of the present invention are explained in detail by referring to diagrams as follows.

FIG. 1 is a diagram showing a typical configuration of a communication system according to an embodiment of the present invention. In this communication system, a communication apparatus 1-1 is connected to an other communication apparatus 1 through a communication network 2. In the case of the typical configuration shown in FIG. 1, a communication apparatus 1-2 serves as the other communication apparatus 1. The communication apparatus 1-1 and 1-2 exchange images of their users as well as user voices with each other in a way similar to the so-called television telephone. In addition, the communication apparatus 1-1 reproduces a content common to the communication apparatus 1-1 and 1-2 synchronously with the communication apparatus 1-2. By displaying a common content in this way, remote communication between users is supported. In the following descriptions, the communication apparatus 1-1 and 1-2 are each referred to simply as the communication apparatus 1 in case it is not necessary to distinguish the communication apparatus 1-1 and 1-2 from each other.

It is to be noted that examples of the common content are a program content obtained as a result of receiving a television broadcast, the content of an already acquired movie or the like obtained by downloading, a private content exchanged between users, a game content, a musical content, and a content prerecorded on an optical disk represented by a DVD (Digital Versatile Disk). It is to be noted that the optical disk itself is not shown in the figure.

The communication apparatus 1 can be utilized by a plurality of users at the same time. In the case of the typical configuration shown in FIG. 1, for example, users A and B utilize the communication apparatus 1-1 whereas a user X utilizes the communication apparatus 1-2.

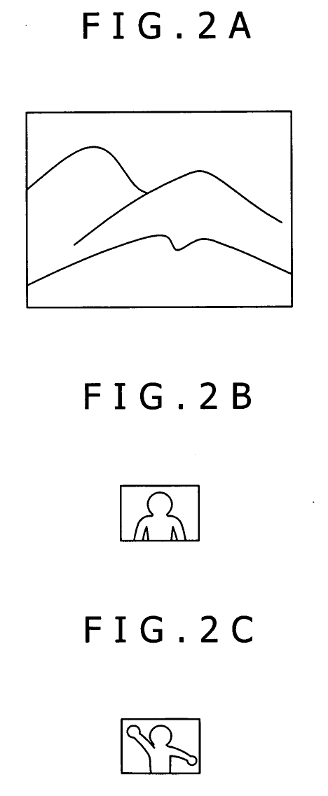

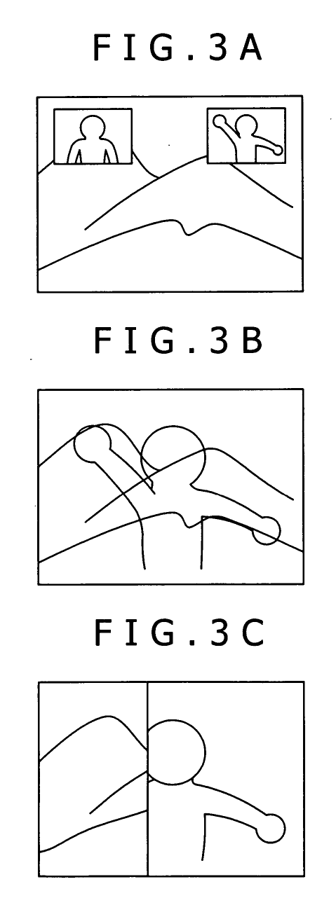

As an example, an image of a common content is shown in FIG. 2A. An image taken by the communication apparatus 1-1 is an image of the user A like one shown in FIG. 2B. On the other hand, an image taken by the communication apparatus 1-2 is an image of the user X like one shown in FIG. 2C. In this case, a display unit 41 employed in the communication apparatus 1-1 as shown in FIG. 4 displays a picture-in-picture screen like one shown in FIG. 3A, a cross-fade screen like one shown in FIG. 3B, or a wipe screen like one shown in FIG. 3C. In either case, the image of the common content and the images of the users are superposed on each other.

It is to be noted that, on the picture-in-picture display like the one shown in FIG. 3A, the images of the users are each superposed on the image of the common content as a subscreen. The position and size of each of the subscreens can be changed in an arbitrary manner. In addition, instead of displaying the images of both the users, that is, instead of displaying both of the image of the user A itself and the image of the user X serving as a communication partner of the user A, only the image of either of the users can be displayed.

In the cross-fade screen like the one shown in FIG. 3B, the image of the common content is synthesized with the image of a user, which can be the user A or X. This cross-fade screen can be used for example when the user points to an arbitrary position or area on the image of the common content.

In the wipe screen like the one shown in FIG. 3C, the image of a user appears on the screen while moving in a certain direction, gradually covering the image of the common content. In the typical screen shown in FIG. 3C, the image of the user appears from the right side.

The above synthesis patterns of the screen can be changed from time to time. In addition, each of the synthesis patterns has synthesis parameters such as image balance to set the transparency of each image in the synthesis patterns shown in FIGS. 3A to 3C and volume balance to set the volumes of the content and the users. These synthesis parameters can also be changed from time to time. A history showing changes of the synthesis pattern from one to another and changes of the synthesis parameters is stored in a synthesis-information storage section 64 as shown in FIG. 4. It is to be noted that the pattern to display the image of the content and the images of the users is not limited to the synthesis patterns described above. That is to say, the images can also be displayed as a synthesis pattern other than the patterns described above.

Refer back to FIG. 1. The communication network 2 is a broad-band data communication network represented by typically the Internet. At a request made by a communication apparatus 1, a content-providing server 3 supplies a content to the communication apparatus 1 by way of the communication network 2. Before a user of a communication apparatus 1 can utilize the communication system, an authentication server 4 authenticates the user. In addition, the authentication server 4 also carries out an accounting process and other processing for a successfully authenticated user.

A broadcasting apparatus 5 is a unit for transmitting a content, which is typically a program of a television broadcast or the like. Thus, the communication apparatus 1 are capable of receiving and reproducing the content from the broadcasting apparatus 5 in a synchronous manner. It is to be noted that the broadcasting apparatus 5 is capable of transmitting a content to the communication apparatus 1 by radio or wire communication. In addition, the broadcasting apparatus 5 may also transmit a content to the communication apparatus 1 by way of the communication network 2.

A standard-time information broadcasting apparatus 6 is a unit for supplying information on a standard time to the communication apparatus 1. The standard time information is used for correctly synchronizing a standard-time measurement section 30, which is employed in each of the communication apparatus 1 as shown in FIG. 4 to serve as a clock, to a standard time. The standard time measured by a clock can typically be the world or Japanese standard time. It is to be noted that the standard-time information broadcasting apparatus 6 is capable of transmitting the information on a standard time to the communication apparatus 1 by radio or wire communication. In addition, the standard-time information broadcasting apparatus 6 may also transmit the information on a standard time to the communication apparatus 1 by way of the communication network 2.

In the typical communication system shown in FIG. 1, only two communication apparatus 1 are connected to each other by the communication network 2. It is also worth noting, however, that the number of communication apparatus 1 connected to the communication network 2 is not limited to two. That is to say, any plurality of communication apparatus 1 including communication apparatus 1-3 and 1-4 can be connected to each other by the communication network 2.

Next, a typical configuration of the communication apparatus 1-1 is explained in detail by referring to FIG. 4.

An output section 21 employed in the communication apparatus 1-1 includes a display unit 41 and a speaker 42. The output section 21 displays an image corresponding to a video signal received from an audio/video synthesis section 26 on the display unit 41 and outputs a sound corresponding to an audio signal received from the audio/video synthesis section 26 to the speaker 42.

The input section 22-1 includes a camera 51-1, a microphone 52-1, and a sensor 53-1. By the same token, the input section 22-2 includes a camera 51-2, a microphone 52-2, and a sensor 53-2. In the following descriptions, the input sections 22-1 and 22-2 are each referred to simply as the input section 22 in case it is not necessary to distinguish the input sections 22-1 and 22-2 from each other. In the same way, the cameras 51-1 and 51-2 are each referred to simply as the camera 51 in case it is not necessary to distinguish the cameras 51-2 and 51-2 from each other. By the same token, the microphones 52-1 and 52-2 are each referred to simply as the microphone 52 in case it is not necessary to distinguish the microphones 52-1 and 52-2 from each other. Likewise, the sensors 53-1 and 53-2 are each referred to simply as the sensor 53 in case it is not necessary to distinguish the sensors 53-1 and 53-2 from each other.

The camera 51 is a component for taking an image of the user. The image of the user can be a moving or still image. The microphone 52 is a component for collecting voices of the user and other sounds. The sensor 53 is a component for detecting information on an environment surrounding the user. The information on the environment includes the brightness, the ambient temperature, and the humidity. The input section 22 outputs the acquired image, voices/sounds, and information on the environment to a communication section 23, a storage section 27, and a data analysis section 28 as RT (Real Time) data of the user. In addition, the input section 22 also outputs the acquired user image and user voices to the audio/video synthesis section 26.

It is to be noted that a plurality of input sections 22 can also be provided, being oriented toward a plurality of respective users. In the case of the communication apparatus 1-1 shown in FIG. 4, for example, two input sections 22 are provided, being oriented toward the two users A and B shown in FIG. 1.

The communication section 23 is a unit for transmitting real-time data input by the input section 22 as data of the users A and/or B to the communication apparatus 1-2 serving as a communication partner by way of the communication network 2 and receiving real-time data of the user X from the communication apparatus 1-2. The communication section 23 supplies the real-time data of the user X to the audio/video synthesis section 26 and the storage section 27. In addition, the communication section 23 also receives a content transmitted by the communication apparatus 1-2 or the content-providing server 3 by way of the communication network 2 and supplies the content to a content reproduction section 25 and the storage section 27. Such a content is also referred to hereafter as content data. The communication section 23 transmits a content and information to the communication apparatus 1-2 by way of the communication network 2. The content is a content read out from the storage section 27, and the information is operation information and control information generated by an operation-information output section 87.

A broadcast receiver section 24 is a unit for receiving a television broadcast signal broadcasted by the broadcasting apparatus 5 and supplying a broadcasted program conveyed by the signal as a content to the content reproduction section 25 and, if necessary, to the storage section 27. The content reproduction section 25 is a unit for reproducing a content, which is a broadcasted program received by the broadcast receiver section 24. The reproduced content may also a content received by the communication section 23, a content read out from the storage section 27, or a content read out from a disk such as an optical disk. It is to be noted that the disk itself is not shown in the figure. The content reproduction section 25 supplies a sound and image of the reproduced content to the audio/video synthesis section 26 and the data analysis section 28. It is to be noted that, at that time, the content reproduction section 25 also outputs auxiliary information such as meta data to the data analysis section 28. The auxiliary information includes an outline of each of scenes composing a content, complementary information, and related information.

The audio/video synthesis section 26 is a unit for mixing an image and sound received from the content reproduction section 25 as an image and sound of a content, an image and voice received from the input section 22 as an image and voice of the user A, an image and voice received from the communication section 23 as an image and voice of the user X as well as a character string for typically arousing the alert for the user A and supplying a video signal obtained as the synthesis result to the output section 21. Referred to hereafter as a synthesis process, the mixing process carried out by the audio/video synthesis section 26 is a process of blending and adjusting images, sounds, voices and character strings.

The storage section 27 includes a content storage section 61, a license storage section 62, a user-information storage section 63, and the synthesis-information storage section 64 mentioned before. The content storage section 61 is a unit for storing data received from the input section 22 as real-time data of a user such as the user A, data received from the communication section 23 as real-time data of the communication partner such as the user X, a broadcast program received from the broadcast receiver section 24 as a content, and a content received from the communication section 23. The license storage section 62 is a unit for storing information such as a license granted to the communication apparatus 1-1 as a license for utilizing a content stored in the content storage section 61. The user-information storage section 63 is a unit for storing data such as information on privacy of a group to which the communication apparatus 1-1 pertains. The synthesis-information storage section 64 is a unit for storing each synthesis pattern and every synthesis parameter, which can be changed by a synthesis control section 84, as synthesis information.

Composed of a content-characteristic analysis section 71 and a control-information generation section 72, the data analysis section 28 is a unit for inputting data received from the input section 22 as real-time data of a user such as the user A, data received from the communication section 23 as real-time data of the communication partner such as the user X, and a content received from the content reproduction section 25.

The content-characteristic analysis section 71 is a unit for analyzing information such as an image and sound of a content or auxiliary information added to the content in order to recognize a characteristic (or the substance) of the content and supplies the characteristic (or the substance) of the content to the control-information generation section 72 as an analysis result.

The control-information generation section 72 is a unit for generating control information to be used for controlling the audio/video synthesis section 26 in accordance with an analysis result received from the content-characteristic analysis section 71. The control-information generation section 72 outputs the generated control information to the control section 32. That is to say, the control-information generation section 72 generates control information to be used for controlling the audio/video synthesis section 26 to synthesize an image and voice included in a content reproduced by the content reproduction section 25 with an image and voice included in real-time data received from the communication section 23 as real-time data of a communication partner in accordance with a synthesis pattern according to the analysis result and synthesis parameters set for the synthesis pattern. Then, the control-information generation section 72 supplies the generated control information to the control section 32. In addition, the control-information generation section 72 generates control information for the communication apparatus 1-2 operated by a communication partner as information used for executing control of the communication apparatus 1-2 in accordance with an analysis result received from the content-characteristic analysis section 71. In the communication apparatus 1-2, the generated control information is supplied to the control section 32.

A communication-environment detection section 29 is a unit for monitoring an environment of communication with the communication apparatus 1-2 through the communication section 23 and the communication network 2 and outputting a result of the monitoring to the control section 32. The environment of communication includes a communication rate and a communication delay time. A standard-time measurement section 30 is a unit for adjusting a standard time measured by itself on the basis of a standard time received from the standard-time information broadcasting apparatus 6 and supplying the adjusted standard time to the control section 32. An operation input section 31 is typically a remote controller for accepting an operation carried out by the user and issuing a command corresponding to the operation to the control section 32.

The control section 32 is a unit for controlling other components of the communication apparatus 1-1 on the basis of information such as a signal representing an operation received by the operation input section 31 as an operation carried out by the user and control information received from the data analysis section 28. The control section 32 includes a session management section 81, a viewing/listening recording level setting section 82, a reproduction synchronization section 83, the aforementioned synthesis control section 84, a reproduction permission section 85, a recording permission section 86, the operation-information output section 87 mentioned above, and an electronic-apparatus control section 88. It is to be noted that, in the typical configuration shown in FIG. 4, control lines used for outputting control commands from the control section 32 to other components of the communication apparatus 1-1 are omitted.

The session management section 81 is a unit for controlling a process carried out by the communication section 23 to connect the communication apparatus 1-1 to other apparatus such as the communication apparatus 1-2, the content-providing server 3, and the authentication server 4 through the communication network 2. In addition, the session management section 81 also determines whether or not to accept control information received from another apparatus such as the communication apparatus 1-2 as information used for controlling sections employed in the communication apparatus 1-1.

The viewing/listening recording level setting section 82 is a unit for determining whether or not real-time data acquired by the input section 22 as data of the user A or other users and/or a content stored in the content storage section 61 as a personal content of the user can be reproduced and recorded by the communication apparatus 1-2, which serves as the communication partner, on the basis of an operation carried out by the user. If the real-time data and/or the personal content are determined to be data and/or a content that can be recorded by the communication apparatus 1-2, the recordable number of times the data and/or the content can be recorded and other information are set. This set information is added to the real-time data of the user as privacy information and transmitted to the communication apparatus 1-2 from the communication section 23. The reproduction synchronization section 83 is a unit for controlling the content reproduction section 25 to reproduce a content common to and synchronously with the communication apparatus 1-2, which serves as the communication partner.

The synthesis control section 84 is a unit for controlling the data analysis section 28 to carry out an analysis for recognizing a characteristic of a reproduced content on the basis of an operation carried out by the user. In addition, the synthesis control section 84 also controls the audio/video synthesis section 26 to synthesize an image of a content with images of users and synthesize a voice of a content with voices of users in accordance with an operation carried out by the user or control information received from the data analysis section 28. That is to say, on the basis of the control information received from the data analysis section 28, the synthesis control section 84 changes setting of the synthesis pattern to any of the patterns shown in FIGS. 3A to 3C and setting of synthesis parameters of the newly set synthesis pattern. The synthesis control section 84 then controls the audio/video synthesis section 26 in accordance with the newly set synthesis pattern and synthesis parameters. In addition, the synthesis control section 84 records the newly set synthesis pattern and synthesis parameters in the synthesis-information storage section 64 as synthesis information.

The reproduction permission section 85 is a unit for outputting a determination result as to whether or not a content can be reproduced on the basis of information such as a license attached to the content and/or the privacy information set by the viewing/listening recording level setting section 82 employed in the communication partner and controlling the content reproduction section 25 on the basis of the determination result. The recording permission section 86 is a unit for outputting a determination result as to whether or not a content can be recorded on the basis of information including a license attached to the content and/or the privacy information and controlling the storage section 27 on the basis of the determination result.

The operation-information output section 87 is a unit for generating operation information for an operation carried out by the user and transmitting the information to the communication apparatus 1-2 serving as the communication partner by way of the communication section 23. The operation carried out by the user can be an operation to change a channel to receive a television broadcast, an operation to start a process to reproduce a content, an operation to end a process to reproduce a content, an operation to reproduce a content in a fast-forward process, or another operation. The operation information includes a description of the operation and a time at which the operation is carried out. Details of the operation information will be described later. The operation information is used in synchronous reproduction of a content. In addition, the operation-information output section 87 also transmits control information received from the data analysis section 28 to the communication apparatus 1-2 by way of the communication section 23.

The electronic-apparatus control section 88 is a unit for setting the output of the output section 21, setting the input of the input section 22, and controlling a predetermined electronic apparatus, which is connected to the communication apparatus 1-1 as a peripheral, on the basis of an operation carried out by the user. Examples of the predetermined electronic apparatus are an illumination apparatus and an air-conditioning apparatus, which are not shown in the figure.

It is to be noted that, since a detailed typical configuration of the communication apparatus 1-2 is the same as that of the communication apparatus 1-1 shown in FIG. 4, no special explanation of the detailed typical configuration of the communication apparatus 1-2 is given.

Next, remote communication processing carried out by the communication apparatus 1-1 to communicate with the communication apparatus 1-2 is explained by referring to a flowchart shown in FIG. 5 as follows. It is to be noted that the communication apparatus 1-2 also carries out this processing in the same way as the communication apparatus 1-1.

The remote communication processing to communicate with the communication apparatus 1-2 is started when an operation to start the remote communication is carried out by the user on the operation input section 31 and an operation signal corresponding to the operation is supplied by the operation input section 31 to the control section 32.

The flowchart shown in the figure begins with a step S1 at which the communication section 23 establishes a connection with the communication apparatus 1-2 through the communication network 2 on the basis of control executed by the session management section 81 in order to notify the communication apparatus 1-2 that a remote communication is started. Then, the flow of the processing goes on to a step S2. In response to this notification, the communication apparatus 1-2 returns an acknowledgement of the notification to the communication apparatus 1-1 as an acceptance of the start of the remote communication.

At the step S2, the communication section 23 starts transmitting real-time data of the user A and other real-time data, which are received from the input section 22, by way of the communication network 2 on the basis of control executed by the control section 32. The communication section 23 also starts receiving real-time data of the user X from the communication apparatus 1-2. Then, the flow of the processing goes on to a step S3. At that time, data received from the input section 22 as the real-time data of the user A and the other real-time data as well as real-time data received from the communication apparatus 1-2 as the real-time data of the user X are supplied to the data analysis section 28. An image and voice included in the real-time data of the user A and an image and voice included the other real-time data as well as an image and voice included in the real-time data of the user X are supplied to the audio/video synthesis section 26.

At the step S3, the communication section 23 establishes a connection with the authentication server 4 through the communication network 2 on the basis of control, which is executed by the session management section 81, in order to carry out an authentication process for acquiring a content. After the authentication process has been completed successfully, the communication section 23 makes an access to the content-providing server 3 through the communication network 2 in order to acquire a content specified by the user. Then, the flow of the processing goes on to a step S4. In the mean time, the communication apparatus 1-2 carries out the same processes as the communication apparatus 1-1 to obtain the same content.

It is to be noted that, if the specified content is a content to be received as a television broadcast or an already acquired content stored in the storage section 27 and ready for reproduction, the process of the step S3 can be omitted.

At the step S4, the content reproduction section 25 starts a process to reproduce the content synchronized with the communication apparatus 1-2 on the basis of control executed by the reproduction synchronization section 83. Then, the flow of the processing goes on to a step S5. By carrying out the process to reproduce the content synchronized with the communication apparatus 1-2, the communication apparatus 1-1 and 1-2 reproduce the same content in a synchronous manner on the basis of a standard time supplied by the standard-time measurement section 30 (or the standard-time information broadcasting apparatus 6). The reproduced content is supplied to the audio/video synthesis section 26 and the data synthesis section 28.

At the step S5, the storage section 27 starts a remote communication recording process. Then, the flow of the processing goes on to a step S6. To put it concretely, the audio/video synthesis section 26 synthesizes the content, the reproduction of which has been started, the images and voices included in the input real-time data of the user A and the other input real-time data as well as the image and voices included in the received real-time data of the user X in accordance with control executed by the synthesis control section 84. Then, the audio/video synthesis section 26 supplies audio and video signals obtained as the synthesis result to the output section 21. It is to be noted that, at that time, the synthesis control section 84 controls the synthesis process, which is carried out by the audio/video synthesis section 26, on the basis of a synthesis pattern and synthesis parameters for the pattern. As described earlier, the synthesis pattern and synthesis parameters for the pattern have been set in advance in accordance with an operation carried out by the user.

The output section 21 displays an image based on the video signal supplied thereto and generates a sound based on the received audio signal. At this stage, exchanges of an image and a voice between the users and a process to reproduce a content in a synchronous manner have been started.

Then, the start of the exchanges of an image and a voice between the users and the process to reproduce a content in a synchronous manner is followed by a start of a process to record the content, the reproduction of which has been started, the images and voices included in the real-time data of the user A and the other real-time data as well as the images and voices included in the real-time data of the user X, and synthesis information including the synthesis pattern and the synthesis parameters set for the synthesis pattern.

At the step S6, in accordance with control executed by the synthesis control section 84, the data analysis section 28 and the audio/video synthesis section 26 carry out a content-characteristic analysis mixing process, details of which will be described later. To be more specific, at the step S6, the data analysis section 28 analyzes an image and voice of a content reproduced by the content reproduction section 25 or auxiliary information of the content in order to recognize the substance and/or characteristic of the content. Then, the data analysis section 28 generates control information, which will be used for controlling sections including the audio/video synthesis section 26, on the basis of the analysis result. In this way, the synthesis control section 84 carries out a process to control synthesis processing executed by the audio/video synthesis section 26 by changing the synthesis pattern to another and properly setting synthesis parameters of the new synthesis pattern on the basis of an operation performed by the user in place of a synthesis pattern determined in advance in accordance with an operation performed by the user and synthesis parameters set in advance as parameters for the determined synthesis pattern.

Then, at the next step S7, the control section 32 produces a determination result as to whether or not the user has carried out an operation to make a request for termination of the remote communication. The control section 32 carries out the process of this step repeatedly till the user carries out such an operation. As the determination result produced in the process carried out at the step S7 indicates that the user has carried out an operation to make a request for termination of the remote communication, the flow of the processing goes on to a step S8.

At the step S8, the communication section 23 establishes a connection with the communication apparatus 1-2 through the communication network 2 on the basis of control, which is executed by the session management section 81, in order to notify the communication apparatus 1-2 that a remote communication has been ended. In response to this notice, the communication apparatus 1-2 returns an acknowledgement of the notification to the communication apparatus 1-1 as an acceptance of the termination of the remote communication.

Then, at the next step S9, the storage section 27 terminates the remote-communication-recording process. It is to be noted that, in this way, when a next remote communication is carried out later on, it is possible to utilize the stored data of the terminated remote communication. The stored data of the terminated remote communication includes the reproduced content, the images and voices included in the real-time data of the user A and the other real-time data as well as the images and voices included in the real-time data of the user X, and the synthesis information described above.

The processing of the remote communication processing carried out by the communication apparatus 1-1 as communication processing between the communication apparatus 1-1 and the communication apparatus 1-2 has been explained above.

The following description explains details of the aforementioned content-characteristic analysis mixing process carried out at the step S6 of the flowchart representing the remote communication processing described above.

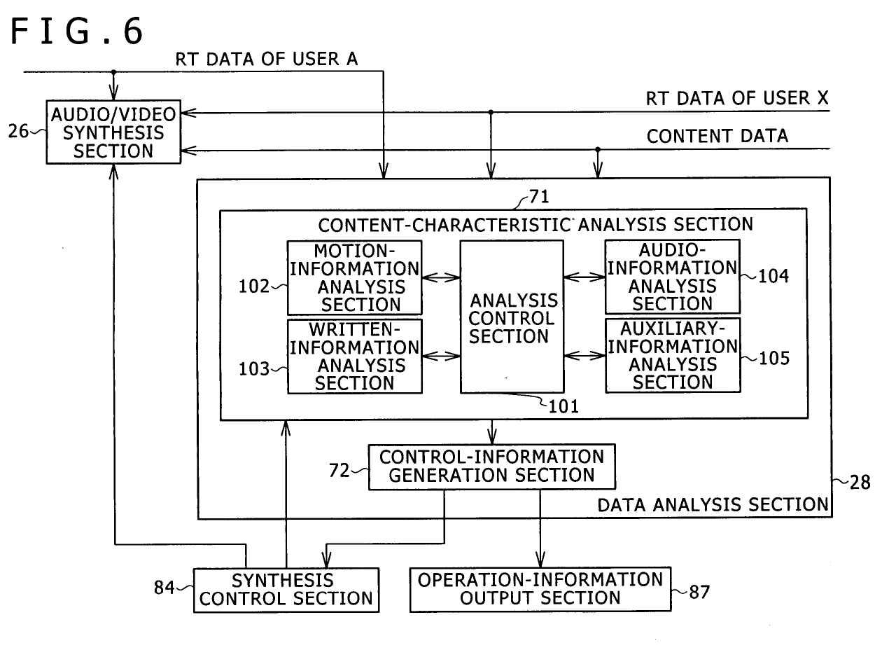

FIG. 6 is a block diagram showing a detailed configuration of the data analysis section 28 for carrying out the content-characteristic analysis mixing process. It is to be noted that, specific configuration sections shown in FIG. 6 as sections identical with their respective counterparts employed in the configuration shown in FIG. 4 are denoted by the same reference numerals as the counterparts, and description of the specific configuration sections is omitted to avoid duplications.

As shown in FIG. 6, a typical configuration of the content-characteristic analysis section 71 includes an analysis control section 101, a motion-information analysis section 102, a written-information analysis section 103, an audio-information analysis section 104, and an auxiliary-information analysis section 105.

The analysis control section 101 is a unit for controlling sections in accordance with control executed by the synthesis control section 84 to analyze an image and voice of a content reproduced by the content reproduction section 25 or auxiliary information of the content in order to recognize the substance and/or characteristic of the content and supplying an analysis result to the control-information generation section 72. The sections controlled by the analysis control section 101 are the motion-information analysis section 102, the written-information analysis section 103, the audio-information analysis section 104, and the auxiliary-information analysis section 105.

The motion-information analysis section 102 is a unit for extracting motion information of a body from a content, analyzing the extracted motion information and supplying the analysis result to the analysis control section 101. The written-information analysis section 103 is a unit for extracting written information from an image of a content, analyzing the extracted written information and supplying the analysis result to the analysis control section 101. The written information extracted from an image of a content includes a news article to be displayed typically on a broadcast program and operation information to be displayed on a game content. Examples of the operation information to be displayed on a game content are parameters and a score.

The audio-information analysis section 104 is a unit for analyzing audio information extracted from sounds of a content and supplying the analysis result to the analysis control section 101. Examples of the audio information are the volume and frequency of a sound. It is to be noted that the audio-information analysis section 104 can be implemented into a configuration for also analyzing information relevant to a sound. Examples of the information relevant to a sound are the number of channels, information indicating a stereo mode, and information indicating a bilingual mode. The auxiliary-information analysis section 105 is a unit for analyzing auxiliary information added to a content and supplying the analysis result to the analysis control section 101.

On the basis of analysis results produced in accordance with control executed by the analysis control section 101, the control-information generation section 72 generates control information to be used for controlling processes carried out by sections employed in the communication apparatus 1-1. The control-information generation section 72 then supplies the control information to the synthesis control section 84. In addition, also on the basis of analysis results received from the analysis control section 101, the control-information generation section 72 generates control information to be used for controlling processes carried out by the audio/video synthesis section 26 employed in the communication apparatus 1-2. In this case, the control-information generation section 72 supplies the control information to the operation-information output section 87.

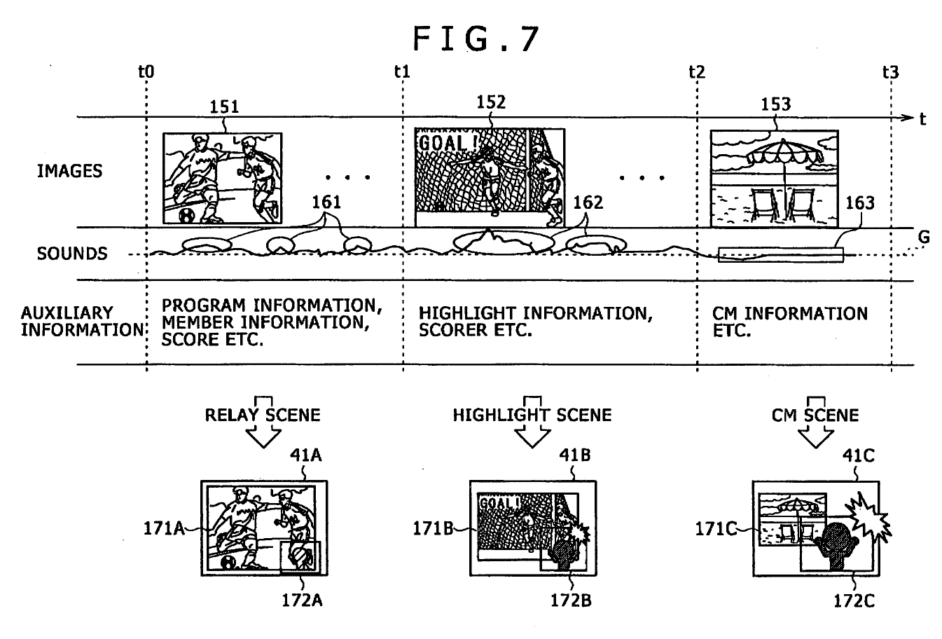

Next, the content-characteristic analysis mixing processing is explained in concrete terms by referring to FIG. 7.

FIG. 7 is a diagram showing a typical configuration of a content shared by users A and X in the remote communication processing represented by the flowchart shown in FIG. 5.

In the case of an example shown in FIG. 7, images, sounds, and auxiliary information, which are components of a content shared by the users A and X, are output concurrently along the time axis. For example, the shared content is a sport such as a soccer game. It is to be noted that, in the example shown in FIG. 7, volume characteristics extracted from sounds are shown as the output sounds. A volume characteristic above a dashed line G represents a large volume while a volume characteristic below the dashed line G represents a small volume.

Scenes of the content displayed in this figure are classified into three types of scene. The types of scene each have a unique characteristic. A scene displayed in a period between times t0 and t1 is a relay scene relaying actual activities in the soccer game. A scene displayed in a period between the time t1 and a time t2 is a highlight scene in the relay of an actual condition of the soccer game. A highlight scene is a scene normally reproduced by a VTR (Video Tape Recorder). A scene displayed in a period between the time t2 and a time t3 is a CM (commercial) scene showing a commercial in the course of the soccer game.

In the relay scene, for example, an image 151 showing a soccer player demonstrating a soccer play is displayed. At that time, a sound having an audio characteristic in the period between times t0 and t1 is output. Thus, a motion change extracted from the image 151 as a change in substance (player) motion is large. In addition, written information stating: “Live” may be superposed on the image 151 of the scene in some cases. It is to be noted that this written information is not shown in the figure.

A sound generated in this relay scene is typically a monotonous commentary made in a scene with a repeated path. Thus, the sound is relatively a quiet sound. In the case of an attacking play, a pre-goal play, or a free kick, however, the sound exhibits a characteristic having cheers here and there. Thus, in this case, the characteristic includes large-volume and small-volume states repeated from time and time as shown by a volume characteristic 161. The content in the relay scene includes auxiliary information such as information on the program of this content, information on members of soccer teams, and a score.

The highlight scene displays for example an image 152 of a scene in which a player makes a goal. Such a scene is typically reproduced by a VTR repeatedly in a replay. At that time, a sound having an audio characteristic in the period between times t1 and t2 is output. In addition, written information stating: “Replay” may be superposed on the image 152 of the scene in some cases. It is to be noted that this written information is not shown in the figure. In many cases, a special editing effect such as slow reproduction of the image 152 may be added.

The sound generated in the highlight scene typically includes loud cheers following production of a goal. In many cases, such cheers last for a relatively long period of time or this scene is repeated. Thus, as shown in a volume characteristic 162, the volume characteristic displays a volume once increased to be followed by a sustained state of the increased volume. The content in the relay scene includes auxiliary information such as highlight information (which is information on the highlight scene) and information on the scorer.

The CM scene displays an image 153 showing an advertisement of a provider presenting the soccer-game program. At that time, a sound having an audio characteristic in the period between times t2 and t3 is output. Thus, the image 153 of the CM scene varies in dependence on the contents of the CM advertisement. In the case of a commercial showing the scenery of a quiet seashore, for example, the quantity of a motion of a body in the image 153 is smaller than the relay scene.

The sound generated in the CM scene has a characteristic different from those of sounds generated during the period between times t0 and t2 as the sounds of the soccer-game program. That is to say, as revealed by a volume characteristic of the example 163 shown in FIG. 7, the volume does not increase and decrease all of a sudden. Instead, the volume stays in approximately a reference state indicated by the dashed line G. Thus, the characteristic is different from those of sounds generated during the period between times t0 and t2 as the sounds of the soccer-game program. The content in the CM scene includes auxiliary information such as CM information, which is information on the CM. It is to be noted that the sound of the commercial is no more than a typical sound. In some cases, in dependence on the contents of a commercial, the sound of the commercial may be different from the volume characteristic 163.

As described above, even for the same content, the image, the sound, and the auxiliary information each have a characteristic varying from scene to scene.

Now, let us assume for example that the user A operates the communication apparatus 1-1 to carry out the remote communication recording process of the step S5 included in the flowchart shown in FIG. 5 to communicate with the user X operating the communication apparatus 1-2. In this case, the image of a content and an image of the user X are synthesized with each other and displayed on the display unit 41 employed in the communication apparatus 1-1 in accordance with the picture-in-picture method explained before by referring to FIG. 3A. At that time, when the user A operates the operation input section 31 to enter a command making a request to start a content-characteristic analysis mixing process, the analysis control section 101 analyzes scenes including an image and sound of a content being reproduced or auxiliary information added to the content in order to recognize a characteristic (or the substance) of the content and supplies the characteristic (or the substance) of the content to the control-information generation section 72 as the analysis result. The control-information generation section 72 generates control information to be used for controlling a process, which is carried out to synthesize the image and sound of the content with the image and voice of the user X, in accordance with the analysis result received from the content-characteristic analysis section 71.

That is to say, in the example shown in FIG. 7, the characteristic analysis mixing process for a scene is carried out in accordance with the characteristic of the scene of the content. It is to be noted that, in other words, in this case, the analysis control section 101 carries out an analysis to recognize the characteristic of a scene in order to determine whether the viewing of the content or the communication processing is important.

First of all, the relay scene is explained. As described above, changes in motion are large in the image 151 showing the soccer game. Thus, the analysis control section 101 (or the motion-information analysis section 102) extracts motion information of a body from the image of the content and analyzes the extracted motion information. That is to say, if the motion information reveals big changes in motions, the analysis control section 101 determines that the motion of a player and/or the development of the game are fast, presuming that the user probably wants to focus itself on the viewing of the content rather than the communication with the communication partner.

Then, in accordance with the analysis result produced by the analysis control section 101, the control-information generation section 72 generates control information to be used for controlling a process of synthesizing images in a way so as to display the image of the user X as a low-concentration image having a small size on a subscreen 172A superposed on a content display 171A as shown in a display screen 41A of FIG. 7. It is to be noted that, at the same time, the control-information generation section 72 generates control information to be used for controlling a process of synthesizing sounds in a way so as to generate the voice of the user X at a volume smaller than the volume of the sound of the content.

In this case, control is executed so that, as shown by the content display 171A, the image 151 of the content is displayed on the display screen 41A, filling up the entire area of the display screen 41A. At the same time, control is also executed so that, the subscreen 172A superposed on the content display 171A as a subscreen showing the image of the user X is displayed as a low-concentration image having a small size so a to give no obstruction to the viewing of the content. In addition, the volume of the voice of the user X is reduced to prevent the viewing of the content from being disturbed.

As a result, the user is capable of obtaining an environment allowing the user to focus itself on the viewing of the content without the need to carry out setting, which consumes time and labor.

If the information on motions reveals only small changes in motions, on the other hand, the analysis control section 101 determines that the motion of a player and/or the development of the game are slow, presuming that the user probably wants to communicate with the communication partner while viewing the content. In this case, in accordance with an analysis result produced by the analysis control section 101, the control-information generation section 72 generates control information to be used for controlling a process of synthesizing images in a way so as to display the image of the user X as a high-concentration image on the subscreen 172A superposed on the content display 171A. At the same time, the control-information generation section 72 generates control information to be used for controlling a process of synthesizing sounds in a way so as to generate the voice of the user X at a volume larger than the volume of the sound of the content.

As a result, the user is capable of obtaining an environment allowing the user to have a communication with a communication partner while viewing the content without the need to carry out setting, which consumes time and labor.

Next, the highlight scene is explained. As described before, the highlight scene is scene having a special editing effect such as a replay carried out by a VTR to reproduce a scene in a content. Thus, the analysis control section 101 analyzes the editing effect of a scene or identifies what the editing effect of the scene is in order to determine whether the communication with the communication partner or the viewing of the content is to be made more lively. In accordance with the analysis result, the control-information generation section 72 generates control information to be used for controlling a process of synthesizing images in a way so as to display a content display 171B and a subscreen 172B superposed on the content display 171B on a display screen 41B shown in FIG. 7.

In the case of the content image 152 reproduced in a replay by a VTR as an image showing a player producing a goal, for example, the analysis result indicates that the user probably wants to share an emotion of viewing the image showing a player producing a goal with the communication partner. Thus, in this case, the control-information generation section 72 generates control information to be used for controlling a process of synthesizing images in a way so as to display the image 152 of the content on a content display 171B with a size smaller a little bit than the content display 171A and an image of the user X on a subscreen 172B at a size larger than the subscreen 172A and a concentration higher than the subscreen 172A as a subscreen superposed on the content display 171B on the display screen 41B. At the same time, in accordance with the size of the subscreen 172B, that is, in accordance with the analysis result, the control-information generation section 72 also generates control information to be used for controlling a process of synthesizing sounds in a way so as to generate a voice of the user X at a volume larger a little bit than the volume of the sound of the user X in the relay scene.

As a result, the user is capable of obtaining an environment allowing the user to share an emotion obtained as a result of viewing the content with a communication partner without the need to carry out setting consuming time and labor.

In addition, also in the case of the CM scene, similar control is executed. That is to say, an analysis result may indicate that the user probably wants to enjoy a conversation with the communication partner during a break given in the course of the content of the soccer game or the user probably wants to exchange opinions on an advertisement shown by an image 153 in the CM scene. In this case, the control-information generation section 72 generates control information to be used for controlling a process of synthesizing images in a way so as to display the image 153 on the display screen 41C shown in FIG. 7 as a content display 171C with a size smaller a little bit than the content display 171B and display a subscreen 172C showing the image of the user X at a size larger than the subscreen 172B and a concentration higher than the subscreen 172B as a subscreen superposed on the content display 171C. At the same time, the control-information generation section 72 generates control information to be used for controlling a process of synthesizing sounds in a way so as to output the voice of the user X at a volume greater a little bit than the volume in the highlight scene in accordance with the size of the subscreen 172C, that is, in accordance with the analysis result.

As a result, the user is capable of obtaining an environment allowing the user to exchange opinions on an advertisement of interest to the user with a communication partner or enjoy a conversation with the communication partner during a break in the course of viewing the content without the need to carry out setting, which consumes time and labor. In this case, since the user is capable of exchanging opinions immediately with the communication partner while viewing an advertisement, a desire to purchase the advertised product or service is aroused in the user.

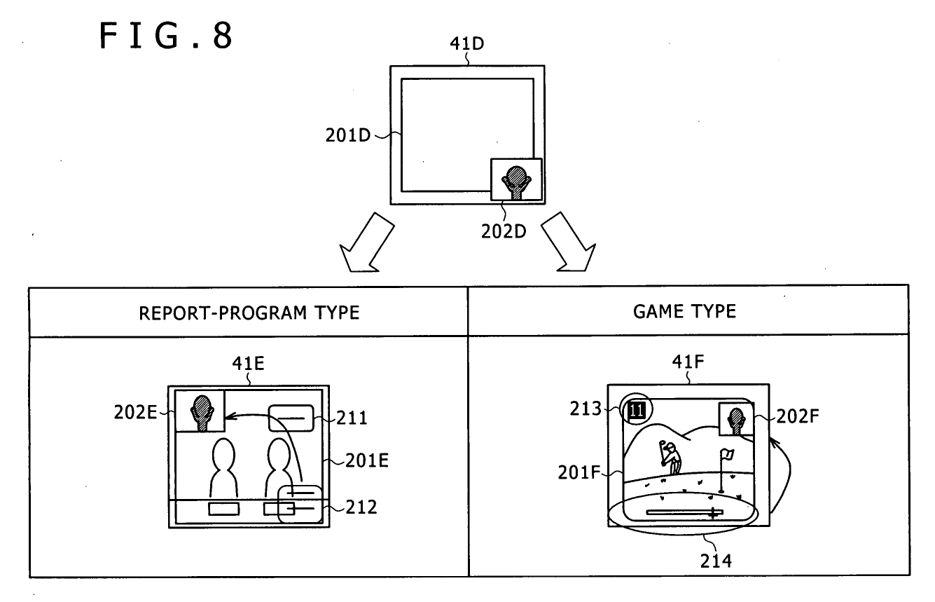

FIG. 8 is a diagram showing another example of the content-characteristic analysis mixing process shown in FIG. 7.

For example, the remote-communication recording process is started at the step S5 of the flowchart shown in FIG. 5, and the synthesis control section 84 controls the synthesis process carried out by the audio/video synthesis section 26 in accordance with a synthesis pattern and parameters set in advance on the basis of an operation carried out by the user. In this case, the image 201D of the content being reproduced is displayed on the display screen 41D of the communication apparatus 1-1 and, at the right bottom corner of the image 201D, the image of the user X serving as the communication partner is displayed as a subscreen 202D superposed on the image 201D.

At that time, when the user A operates the operation input section 31 to enter a command making a request to start a content-characteristic analysis mixing process, the analysis control section 101 detects the type of the content from typically the auxiliary information added to the content and analyzes the detected type of the content in order to recognize a configuration characteristic of the image of the content or a configuration characteristic of the display screen of the content. In accordance with the analysis result, the control-information generation section 72 generates control information to be used for controlling processes to synthesize the image and sound of the content with the image and voice of the user serving as a communication partner. That is to say, in the case of the example shown in FIG. 8, a characteristic analysis mixing process is carried out in accordance with the characteristic of the content type and/or the configuration characteristic of the image.

Let us assume for example that the content is a broadcast program composed of an image and much written information in the image. Examples of such a content are news and a tabloid show. In this case, the analysis control section 101 (or the written-information analysis section 103) extracts the written information from the image of the content by adoption of a method such as a character recognition technique or a fixed display portion recognition technique and analyzes the written information in order to recognize the position of the information on the image. In accordance with the analysis result produced by the analysis control section 101, the control-information generation section 72 generates control information to be used for controlling a process of synthesizing images in a way so as to move a subscreen used for displaying the image of the user X to a location displaying no written information.

Let us assume that, as shown by a display screen 41E in FIG. 8, written information 211 is displayed at a right upper corner of the image 201E of the content as a subscreen superposed on the image 201E and written information 212 is displayed at a right lower corner of the image 201E as a subscreen superposed on the image 201E. In this case, if another subscreen is synthesized at the right lower corner of the image 201E as a subscreen 202D is, the subscreen will be superposed on the written information 212 and the written information 212 will be hardly visible. For this reason, the analysis control section 101 extracts the pieces of written information 211 and 212 from the image 201E of the content and analyzes the pieces of written information 211 and 212 in order to recognize their positions on the image 201E. In accordance with the analysis result produced by the analysis control section 101, the control-information generation section 72 generates control information to be used for controlling a process of synthesizing images in a way so as to move a subscreen used for displaying the image of the user X to a location displaying no written information. In this example, the subscreen is moved to the left upper corner and displayed at this corner as a subscreen 202E.

In this way, written information of a content can be prevented from becoming hardly visible without requiring the user to carry out a manual operation.

In addition, let us assume for example that the content is a game composed of much information displayed on the image of the content as information on how to operate the communication apparatus 1-1. The information on how to operate the communication apparatus 1-1 includes parameters and a score. In this case, the analysis control section 101 (or the written-information analysis section 103) extracts the written information and the operation information from the image of the content by adoption of a method such as a character recognition technique or a fixed display portion recognition technique and analyzes the extracted written information and the operation information in order to recognize the positions of the pieces of information on the image. In accordance with the analysis result produced by the analysis control section 101, the control-information generation section 72 generates control information to be used for controlling a process of synthesizing images in a way so as to move or shrink a subscreen used for displaying the image of the user X to a location displaying neither the written information nor the operation information to prevent the subscreen from being superposed on the written information and the operation information.

Let us assume that, as shown by a display screen 41F in FIG. 8, a score 213 is displayed at a left upper corner of the image 201F of the content as a subscreen superposed on the image 201F and parameters 214 are displayed at on the bottom of the image 201F as a subscreen superposed on the image 201F. In this case, if another subscreen is synthesized at the right lower corner of the image 201F as a subscreen 202D is, the subscreen will be superposed on the parameters 214 and the parameters 214 will be hardly visible. For this reason, the analysis control section 101 extracts the operation information such as the score 213 and the parameters 214 from the image 201F of the content and analyzes the score 213 and the parameters 214 in order to recognize their positions on the image 201F. In accordance with the analysis result produced by the analysis control section 101, the control-information generation section 72 generates control information to be used for controlling a process of synthesizing images in a way so as to move a subscreen used for displaying the image of the user X to a location away from the operation information. In this example, the subscreen used for displaying the image of the user X is moved to the right upper corner of the image 201F of the content and displayed at this corner as a subscreen 202F.

In this way, information on how to operate a content can be prevented from becoming hardly visible without requiring the user to carry out a manual operation.

In the example shown in FIG. 8, the content is a broadcast program or a game. It is to be noted, however, that the types of the content are not limited to the broadcast program and the game. For example, the content can be a movie displaying captions.

In the above descriptions, the picture-in-picture method is assumed. However, the scope of the present invention is not limited to the picture-in-picture method. That is to say, the present invention can also be applied to the cross fade method explained earlier by referring to FIG. 3B, the wipe method explained before by referring to FIG. 3C, and other synthesis patterns.

In addition, the above descriptions explain only syntheses of an image and voice of each communication partner with an image and sound of a content. However, an image and voice input by the input section 22 as an image and voice of the user A can also be synthesized with an image and sound of a content.

Next, the content-characteristic analysis mixing process carried out at the step S6 of the flowchart shown in FIG. 5 is explained by referring to a flowchart shown in FIG. 9 as follows.

At the step S5 of the flowchart shown in FIG. 5, a remote-communication recording process is started. Then, on the basis of a synthesis pattern and synthesis parameters set in advance by an operation carried out by the user, and the synthesis control section 84 carries out a process to control the synthesis processing performed by the audio/video synthesis section 26. In addition, the data analysis section 28 obtains a reproduced content, input real-time data of the user A and other users, and received real-time data of the user X.

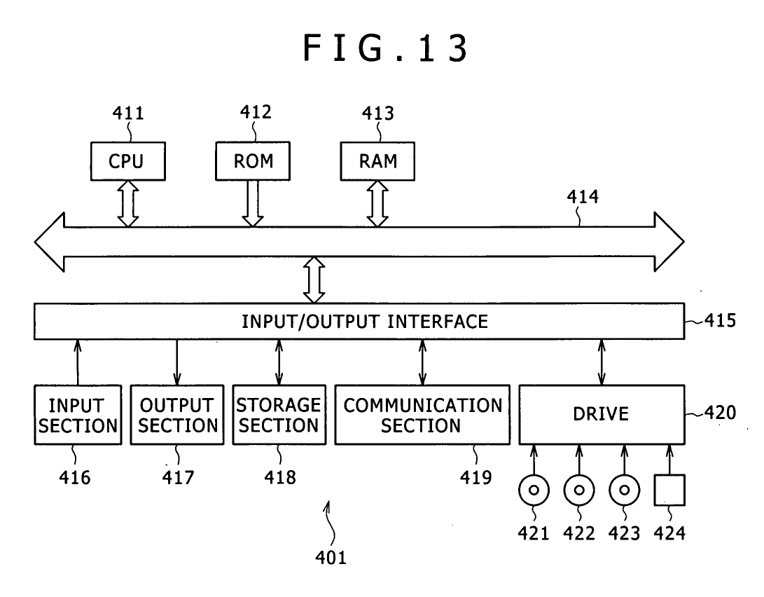

Then, the user A operates the operation input section 31 to enter a command making a request for a start of the content-characteristic analysis mixing process. The operation input section 31 generates an operation signal corresponding to the operation carried out by the user A and supplies the operation signal to the synthesis control section 84. Receiving the operation signal from the operation input section 31, at the first step S21 of the flowchart shown in FIG. 13, the synthesis control section 84 produces a determination result as to whether or not to start the content-characteristic analysis mixing process. If the determination result indicates that the content-characteristic analysis mixing process is to be started, the flow of the processing goes on to a step S22 at which the synthesis control section 84 controls the data analysis section 28 to carry out a content analysis process.

As will be described later in detail by referring to a flowchart shown in FIG. 10 as a flowchart representing the content analysis process, in the content analysis process carried out at the step S22 of the flowchart shown in FIG. 9, the image and sound of a content or auxiliary information added to the content is analyzed in order to recognize the substance and/or characteristic of the content. In addition, control information is generated to be used for controlling the audio/video synthesis section 26 to carry out a process of synthesizing an image and sound of the content with an image and voice included in real-time data of a user, which serves as the communication partner, in accordance with a synthesis pattern according to an analysis result and synthesis parameters set for the pattern. The control information is then supplied to the synthesis control section 84. It is to be noted that, if control information to be used for controlling the audio/video synthesis section 26 employed in the communication apparatus 1-2 operated by the communication partner is also generated, the generated control information is supplied to the operation-information output section 87.

After completing the process carried out at the step S22, the flow of the processing goes on to a step S23 at which, in accordance with control information received from the control-information generation section 72, the synthesis control section 84 sets a synthesis pattern for the audio/video synthesis section 26 and synthesis parameters for the synthesis pattern, controlling the audio/video synthesis section 26 to carry out a process of synthesizing an image and sound of the content with an image and voice included in real-time data of a user, which serves as the communication partner. Then, the flow of the processing goes on to a step S24.

Thus, the display unit 41 employed in the output section 21 shows an image of the content and an image of a user serving as the communication partner as a result of a process to synthesize the images in accordance with control information generated by the control-information generation section 72 on the basis of a synthesis result produced by the content-characteristic analysis section 71. By the same token, the speaker 42 employed in the output section 21 generates a sound of the content and a voice of the user serving as the communication partner as a result of a process to synthesize the sounds in accordance with control information generated by the control-information generation section 72 on the basis of a synthesis result produced by the content-characteristic analysis section 71.

Then, a synthesis pattern and synthesis parameters updated in accordance with control information generated by the control-information generation section 72 are recorded as synthesis information along with the content, the reproduction of which has been started, the images and voices included in the input real-time data of the user A and the other input real-time data as well as the image and voices included in the received real-time data of the user X.

Subsequently, at the next step S24, the operation-information output section 87 transmits control information received from the control-information generation section 72 as the control information for the communication apparatus 1-2 operated by the user X to the communication apparatus 1-2 by way of the communication section 23 and the communication network 2. Then, the flow of the processing goes on to a step S25. It is to be noted that processing carried out by the communication apparatus 1-2 receiving the control information from the communication apparatus 1-1 will be described later.

The user A may operate the operation input section 31 to enter a command making a request for an end of the content-characteristic analysis mixing process. In this case, the operation input section 31 generates an operation signal corresponding to the operation carried out by the user A and supplies the operation signal to the synthesis control section 84. At the next step S25 cited above, on the basis of such an operation signal from the operation input section 31, the synthesis control section 84 produces a determination result as to whether or not to end the content-characteristic analysis mixing process. If the determination result indicates that the content-characteristic analysis mixing process is to be ended, the content-characteristic analysis mixing process is terminated and the flow of the processing goes back to the step S7 included in the flowchart shown in FIG. 5 as a step following the step S6.

If the determination result produced in the process carried out at the step S25 indicates that the content-characteristic analysis mixing process is not to be ended, on the other hand, the flow of the processing goes back to the step S22.

If the determination result produced in the process carried out at the step S21 indicates that the content-characteristic analysis mixing process is not to be started, on the other hand, the content-characteristic analysis mixing process is terminated and the flow of the processing goes back to the step S7 included in the flowchart shown in FIG. 5 as a step following the step S6. That is to say, at the step S7, the synthesis control section 84 continues to perform processing of controlling a synthesis process carried out by the audio/video synthesis section 26 on the basis of a synthesis pattern and synthesis parameters set in advance in accordance with an operation performed by the user until the user executes an operation to make a request for termination of the remote communication.

Next, by referring to a flowchart shown in FIG. 10, the following description explains details of the content analysis process carried out at the step S22 of the flowchart shown in FIG. 9. It is to be noted that the content analysis process represented by the flowchart shown in FIG. 10 is a characteristic analysis mixing process carried out in accordance with the characteristic of a scene of the content as explained earlier by referring to FIG. 7.

At the first step S51 of the flowchart shown in FIG. 10, the analysis control section 101 controls the motion-information analysis section 102, the written-information analysis section 103, the audio-information analysis section 104, or the auxiliary-information analysis section 105 to detect a scene of a content, which is reproduced by the content reproduction section 25, on the basis of the image and sound of the content or auxiliary information added to the content. The scene can be detected to be one of the relay scene, the highlight scene, and the CM scene, which have been explained earlier by referring to FIG. 7.

To put it concretely, the analysis control section 101 controls at least one of the motion-information analysis section 102, the written-information analysis section 103, the audio-information analysis section 104, and the auxiliary-information analysis section 105 to detect a scene of a content. In accordance with the control executed by the analysis control section 101, the motion-information analysis section 102, the written-information analysis section 103, the audio-information analysis section 104, and the auxiliary-information analysis section 105 carry out their respective processing as follows.

The motion-information analysis section 102 extracts motion information of a body from the image of the content and analyzes the extracted information in order to determine the quantity of the motion in the content. The motion quantity obtained as the analysis result is used to recognize the type of a scene. If the quantity of the motion in the content is found large, for example, the scene is determined to be a relay scene.

The written-information analysis section 103 extracts written information from the image of the content and analyzes the extracted information. For example, the analysis result indicates that the written information extracted from the image 151 shown in FIG. 7 is “Live” and the written information extracted from the image 152 is “Replay.” On the basis of the analysis result, the written-information analysis section 103 recognizes the type of each scene. If the written information states “Live,” for example, the scene is determined to be a relay scene. In this way, the type of each scene can be recognized.

The audio-information analysis section 104 extracts sound-volume characteristics 161 to 163 shown in FIG. 7 from the sound of the content and analyzes the extracted sound-volume characteristics in order to recognize the type of each scene on the basis of the analysis result. If the analysis result indicates that the sound-volume characteristic changes all of a sudden as is the case with the sound-volume characteristic 163, for example, the scene is determined to be a CM scene. In this way, the type of each scene can be recognized.

The auxiliary-information analysis section 105 extracts auxiliary information from the content and analyzes the extracted auxiliary information in order to recognize the type of each scene on the basis of the analysis result. If the extracted auxiliary information includes a score as is the case with the auxiliary information of the example shown in FIG. 7, for example, the scene is determined to be a relay scene. In this way, the type of each scene can be recognized. It is to be noted that auxiliary information may also be added in advance to the content including a scene having a special editing effect as auxiliary information indicating that the scene has a special editing effect. In this case, the auxiliary-information analysis section 105 analyzes the auxiliary information in order to recognize the type of the scene. An example of a scene having a special editing effect is a highlight scene.

It is to be noted that the methods to carry out an analysis process in order to detect a scene can be combined and are not limited to those described above. That is to say, another analysis method to detect a scene can also be adopted.

As described above, at the step S51, a scene is detected. Then, at the next step S52 and the subsequent steps, control information for controlling a synthesis process is generated on the basis of the detected characteristic of a scene.

At the step S52, the analysis control section 101 produces a determination result as to whether or not the scene detected at the step S51 is a relay scene. If the determination result indicates that the scene detected at the step S51 is a relay scene, the flow of the processing goes on to a step S53 at which the analysis control section 101 controls the motion-information analysis section 102 to extract motion information of a body from the image of the content, analyze the extracted information in order to recognize the quantity of the motion in the content and produce the determination result as to whether or not the recognized quantity of the motion is large.

It is to be noted that, if the quantity of the motion in the content has already been recognized as the analysis result process carried out at the step S51, the motion-information analysis section 102 produces a determination result as to whether or not the recognized quantity of the motion is large at the step S53 on the basis of the analysis result process carried out at the step S51.

If the determination result produced in the process carried out at the step S53 indicates that the recognized quantity of the motion is large, that is, if the determination result indicates that the motion of a player and/or the development of the game are fast, presuming that the user probably wants to focus itself on the viewing of the content rather than the communication with the communication partner, the analysis control section 101 supplies the analysis result to the control-information generation section 72. Then, the flow of the processing goes on to a step S54.

At the step S54, in accordance with the analysis received from the analysis control section 101, the control-information generation section 72 generates control information to be used for controlling a process to synthesize images in such a way that the subscreen 172A showing the image of the user X is displayed at a low concentration superposed on the content display 171A appearing on the display screen 41A shown in FIG. 7 and, at the same time, generates control information to be used for controlling a process to synthesize sounds in a way so as to output the voice of the user X at a volume smaller than the volume of the sound of the content. Then, the control-information generation section 72 supplies the generated control information to the synthesis control section 84 and terminates the content analysis processing. Finally, the flow of the processing goes back to the step S23 included in the flowchart shown in FIG. 9 as a step following the step S22.

On the other hand, if the determination result produced in the process carried out at the step S53 indicates that the recognized quantity of the motion is not large, that is, if the determination result indicates that the motion of a player and/or the development of the game are slow, presuming that the user probably wants to communicate with the communication partner while viewing the content, the analysis control section 101 supplies the analysis result to the control-information generation section 72. Then, the flow of the processing goes on to a step S55.

At the step S55, in accordance with the analysis received from the analysis control section 101, the control-information generation section 72 generates control information to be used for controlling a process to synthesize images in such a way that a subscreen 172A showing the image of the user X is displayed at a high concentration superposed on the content display 171A appearing on the display screen 41A shown in FIG. 7 and, at the same time, generates control information to be used for controlling a process to synthesize sounds in a way so as to output the voice of the user X at a volume larger a little bit than the volume of the sound of the content in comparison with the control information generated in a process carried out at the step S54. Then, the control-information generation section 72 supplies the generated control information to the synthesis control section 84 and terminates the content analysis processing. Finally, the flow of the processing goes back to the step S23 included in the flowchart shown in FIG. 9 as a step following the step S22.

If the determination result produced in the process carried out at the step S52 indicates that the scene detected at the step S51 is not a relay scene, on the other hand, the flow of the processing goes on to a step S56 at which the analysis control section 101 produces a determination result as to whether or not the scene detected at the step S51 is a highlight scene.

If the determination result produced in the process carried out at the step S56 indicates that the scene detected at the step S51 is a highlight scene as is the case with the content image 152 reproduced in a replay by a VTR as an image showing a player producing a goal as shown in the example of FIG. 7, the analysis result indicates that the user probably wants to share an emotion of viewing the content with the communication partner. In this case, the analysis control section 101 supplies the analysis result to the control-information generation section 72. Then, the flow of the processing goes on to a step S57.

At the step S57, in accordance with the analysis result received from the analysis control section 101, the control-information generation section 72 generates control information to be used for controlling a process of synthesizing images in a way so as to display the image 152 of the content on a content display 171B with a size smaller a little bit than the content display 171A and display an image of the user X at a size larger than the subscreen 172A and a concentration higher than the subscreen 172A as a subscreen 172B superposed on the content display 171B on the display screen 41B shown in FIG. 7. At the same time, the control-information generation section 72 also generates control information to be used for controlling a process of synthesizing sounds in a way so as to generate a voice of the user X at a volume larger a little bit than the volume of the sound of the content in comparison with the control information generated in a process carried out at the step S54. Then, the control-information generation section 72 supplies the generated control information to the synthesis control section 84 and terminates the content analysis processing. Finally, the flow of the processing goes back to the step S23 included in the flowchart shown in FIG. 9 as a step following the step S22.

If the determination result produced in the process carried out at the step S56 indicates that the scene detected at the step S51 is not a highlight scene, that is, if the scene detected at the step S51 is a CM scene in the case of the example shown in FIG. 7, on the other hand, the analysis result may for example indicate that the user probably wants to exchange opinions on typically an advertisement shown by the image 153 in the CM scene. In this case, the analysis control section 101 supplies the analysis result to the control-information generation section 72. Then, the flow of the processing goes on to a step S58.

At the step S58, in accordance with the analysis received from the analysis control section 101, the control-information generation section 72 generates control information to be used for controlling a process of synthesizing images in a way so as to display the image 153 on the display screen 41C shown in FIG. 7 as a content display 171C with a size smaller a little bit than the content display 171B and display a subscreen 172C showing the image of the user X at a size larger than the subscreen 172B and a concentration higher than the subscreen 172B as a subscreen superposed on the content display 171C. At the same time, the control-information generation section 72 generates control information to be used for controlling a process of synthesizing sounds in a way so as to output the voice of the user X at a volume larger a little bit than the sound of the content in comparison with the control information generated in a process carried out at the step S57. Then, the control-information generation section 72 supplies the generated control information to the synthesis control section 84 and terminates the content analysis processing. Finally, the flow of the processing goes back to the step S23 included in the flowchart shown in FIG. 9 as a step following the step S22.

As described above, the pieces of control information generated in the processes carried out at the steps S54, S55, S57, and S58 of the flowchart shown in FIG. 10 are supplied to only the synthesis control section 84. It is to be noted that, if control information for controlling the audio/video synthesis section 26 employed in the communication apparatus 1-2 operated by the user X serving as a communication partner is also generated at the same time, the control information is supplied to the operation-information output section 87. It is also worth noting that, in this case, a subscreen on the display in the communication apparatus 1-2 shows an image of the user A operating the communication apparatus 1-1 in place of the image of the user X.

Thus, since the communication apparatus operated by a communication partner can also be controlled as well, the user and a communication partner can view their respective display screens having the same configuration except that the subscreens on the display screens show images different from each other.

As described above, the image and sound of a content as well as auxiliary information added to the content are analyzed in order to recognize the characteristic of the content and/or the characteristic of the quantity of a change in motion. Then, the analysis result is used as a basis for controlling a process to synthesize the image and sound of the content with respectively the image and voice of the communication partner. It is thus possible to realize a communication reflecting the substance of the content in a real-time manner. As a result, it is possible to produce an effect of implementation of a face-to-face communication in spite of the fact that the users are present at locations remote from each other.

In addition, since it is possible to easily set a process, which used to be a difficult process as well as a time and labor-consuming process in the past, in any specific communication apparatus as a process to synthesize the image and voice of another user operating another communication apparatus in accordance with the substance and characteristic of a content, the user can eliminate the time for operating the specific communication apparatus and the labor to carry out the setting.

Next, by referring to a flowchart shown in FIG. 11, the following description explains details of another typical implementation of the content analysis process carried out at the step S22 of the flowchart shown in FIG. 9. It is to be noted that the content analysis process represented by the flowchart shown in FIG. 11 is a characteristic analysis mixing process carried out in accordance with the characteristic of the type of the content as explained earlier by referring to FIG. 8.

At the first step S71 of the flowchart shown in FIG. 11, the analysis control section 101 controls the auxiliary-information analysis section 105 to detect auxiliary information added to a content reproduced by the content reproduction section 25 and analyze the detected auxiliary content in order to recognize the type of the content. Then, the flow of the processing goes on to a step S72.

At the step S72, the analysis control section 101 produces a determination result as to whether or not the content type recognized at the step S71 is the type of a broadcast program having a characteristic including much written information in an image thereof. If the determination result indicates that the recognized content type is the type of a broadcast program, the flow of the processing goes on to a step S73 at which the position of the written information on the image of the content (that is, the location at which the written information is displayed on the image of the content) is recognized as the analysis result. Then, the flow of the processing goes on to a step S74.

At the step S74, in accordance with the analysis result produced by the analysis control section 101, the control-information generation section 72 generates control information to be used for controlling a process of synthesizing images in a way so as to move a subscreen used for displaying the image of the user X to a location displaying no operation information, and supplies the control information to the synthesis control section 84. Then, the content analysis processing is terminated. Finally, the flow of the processing goes back to the step S23 included in the flowchart shown in FIG. 9 as a step following the step S22.

If the determination result produced in the process carried out at the step S72 indicates that the recognized content type is not the type of a broadcast program, on the other hand, the flow of the processing goes on to a step S75 at which the analysis control section 101 produces a determination result as to whether or not the content type recognized at the step S71 is the type of a game having a characteristic including much operation information in an image thereof. If the determination result indicates that the recognized content type is the type of a game, the flow of the processing goes on to a step S76.

At the step S76, the analysis control section 101 identifies the position of the operation information on the image of the content (that is, the location at which the operation information is displayed on the image of the content) as the analysis result. Then, the flow of the processing goes on to a step S77.

At the step S77, in accordance with the analysis result produced by the analysis control section 101, the control-information generation section 72 generates control information to be used for controlling a process of synthesizing images in a way so as to move a subscreen used for displaying the image of the user X to a location displaying no operation information and reduce the size of the subscreen if necessary, supplying the control information to the synthesis control section 84. Then, the content analysis processing is terminated. Finally, the flow of the processing goes back to the step S23 included in the flowchart shown in FIG. 9 as a step following the step S22.

If the determination result produced in the process carried out at the step S75 indicates that the content type recognized at the step S71 is not the type of a game, that is, if the determination result indicates that the recognized content type is another type of content, on the other hand, the flow of the processing goes back to the step S23 included in the flowchart shown in FIG. 9 as a step following the step S22.

Much like the flowchart shown in FIG. 10, the pieces of control information generated in the processes carried out at the steps S74 and S77 of the flowchart shown in FIG. 11 are supplied to only the synthesis control section 84. It is to be noted that, if control information for controlling the audio/video synthesis section 26 employed in the communication apparatus 1-2 operated by the user X serving as a communication partner is also generated at the same time, the control information is supplied to the operation-information output section 87.

As described above, the image and sound of a content as well as auxiliary information added to the content are analyzed in order to recognize the type of the content and/or the configuration characteristic of the image of the content. Then, the analysis result is used as a basis for controlling a process to synthesize the image and sound of the content with respectively the image and voice of a communication partner. It is thus possible to realize a communication reflecting the substance and characteristic of the content in a real-time manner. As a result, it is possible to produce an effect of implementation of a face-to-face communication in spite of the fact that the users are present at locations remote from each other.

In addition, since it is possible to easily set a process, which used to be a difficult process as well as time and labor-consuming process in the past, in any specific communication apparatus operated by a user as a process to synthesize the image and voice of another user operating another communication apparatus in accordance with the substance and characteristic of a content, the user can eliminate the time for operating the specific communication apparatus and the labor to carry out the setting.

The communication apparatus operated by a communication partner can also be controlled as well.

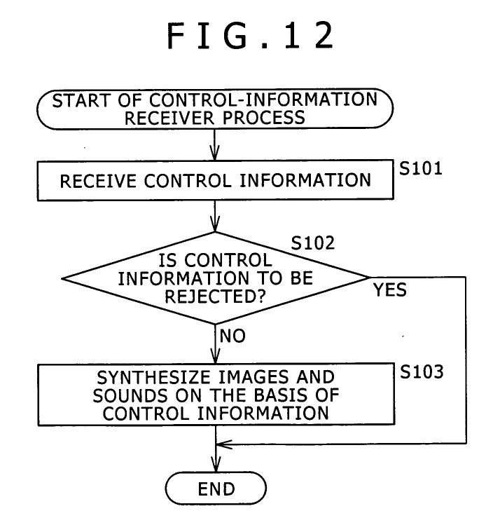

Next, by referring a flowchart shown in FIG. 12, the following description explains control-information receiver processing carried out by the communication apparatus 1-2 to receive control information transmitted by the communication apparatus 1-1 in the process carried out at the step S24 of the flowchart shown in FIG. 9.

It is to be noted that the control-information receiver processing represented by the flowchart shown in FIG. 12 is processing carried out by the communication apparatus 1-2 while the remote-communication recording processing is being performed after the step S5 of the flowchart shown in FIG. 5. That is to say, the control-information receiver processing is a mixing process carried out by the communication apparatus 1-2 in accordance with a result of a content-characteristic analysis performed by the other communication apparatus 1-1.

The flowchart shown in FIG. 12 begins with a step S101 at which the communication section 23 employed in the communication apparatus 1-2 receives control information from the operation-information output section 87 employed in the communication apparatus 1-1 and supplies the control information to the session management section 81.

Then, at the next step S102, the session management section 81 produces a determination result as to whether or not the control information received from the communication apparatus 1-1 is information that would result in an operation and/or effect not desired by the user X. If the determination result indicates that the control information is information that would result in an operation and/or effect not desired by the user X, the session management section 81 makes a decision to reject the information. Finally, the control-information receiver processing is ended.

Let us keep in mind that it is also possible to set the communication apparatus 1-2 to optionally accept or reject control information received from the communication apparatus 1-1 or completely reject such information. In addition, it is also possible to provide a configuration in which, if control information is accepted in the communication apparatus 1-2, the communication apparatus 1-2 itself analyzes the information and priority levels are set for exclusive execution of generated control information or a master-slave relation is set in advance among the communication apparatus.

If the determination result produced by the session management section 81 in the process carried out at the step S102 indicates that the control information received from the communication apparatus 1-1 is not information to be rejected, on the other hand, the control information is supplied to the synthesis control section 84. Then, the flow of the processing goes on to a step S103.

At the step S103, the synthesis control section 84 sets a synthesis pattern for the audio/video synthesis section 26 and synthesis parameters for the synthesis pattern in accordance with the control information received from the control-information generation section 72. Then, the synthesis control section 84 controls the audio/video synthesis section 26 to synthesize an image and sound of the content with the image and voice of the user serving as a communication partner. Finally, the control-information receiver processing is ended.

As described above, it is possible to use not only control information generated by the control-information generation section 72 in accordance with an analysis result carried out by the user-characteristic analysis section 71 employed in the communication apparatus itself, but also control information generated by the control-information generation section 72 in accordance with an analysis result carried out by the user-characteristic analysis section 71 employed in another communication apparatus. In addition, the control information can also be rejected.

Thus, since the communication apparatus operated by a communication partner can also be controlled as well, the user and a communication partner can view their respective display screens having the same configuration except that the subscreens on the display screens show images different from each other. As a result, a more natural communication can be carried out.

It is to be noted that the above descriptions assume that each communication apparatus includes a data analysis section 28. However, a server including the data analysis section 28 may also be connected to the communication network 2 to serve as an apparatus for providing control information to each communication apparatus. As an alternative, the server can also be provided with only the content-characteristic analysis section 71 so that the server is capable of giving analysis information to each communication apparatus.

Since remote communication processing is carried out as described above, more lively and natural communications can be implemented in comparison with equipment including the telephone set in related art, the TV telephone set, and remote communication apparatus such as the video conference system.

That is to say, in the case of the communication in related art, the user X using a TV set in related art to view and listen to a broadcast content distributed in a real-time manner utilizes an audio telephone set to express an impression of the broadcast content viewed and listened to by the user X to the user A present at a remote location. In this case, it is difficult for the user A, who does not actually view and listen to the broadcast content, to understand the impression of the situation.

By using the communication apparatus according to an embodiment of the present invention, however, the users A and X present at locations remote from each other are capable of sharing the content at the same time and, in addition, the images of the users A and X can be reproduced on subscreens or the like while their voices can be heard. Thus, in spite of the fact that the users A and X are present at locations remote from each other, it is possible to provide a high realistic sensation, a sense of togetherness, and a sense of intimacy as if a face-to-face communication were being carried out.

In accordance with the substance and characteristic of a content, processing such as a process to synthesize the image and sound of the content with the image and sound of a user can be controlled. Thus, parameters of a communication apparatus can be set easily without taking much time and labor. As a result, more lively and natural communications can be implemented.

The series of processes carried out by the communication apparatus 1 as described previously can be carried out by hardware and/or execution of software. In this case, each of the communication apparatus 1-1 and 1-2 shown in FIG. 1 is typically implemented by a personal computer 401 like one shown in FIG. 13.

In the personal computer 401 shown in FIG. 13, a CPU (Central Processing Unit) 411 is a component for carrying out various kinds of processing by execution of a variety of programs stored in advance in a ROM (Read Only Memory) 412 or loaded into a RAM (Random Access Memory) 413 from a storage section 418. The RAM 413 is also used for properly storing data by the CPU 411 in the executions of the programs.

The CPU 411, the ROM 412, and the RAM 413 are connected to each other through a bus 414. The bus 414 is also connected to an input/output interface 415.

The input/output interface 415 is connected to an input section 416, an output section 417, the storage section 418 mentioned above, and a communication section 419. Used for receiving a command entered by the user, the input section 206 includes input devices such as a keyboard and a mouse, whereas the output section 207 includes a display unit for displaying an image and a speaker for outputting a generated sound. The display unit is typically a CRT (Cathode Ray Tube) display unit or an LCD (Liquid Crystal Display) unit. The storage section 418 is typically a hard-disk drive including an embedded hard disk used for storing a variety of programs and various kinds of data. The communication section 419 including a modem and a terminal adapter is a unit for carrying out radio or wire communication processing with other apparatus through a network.

The input/output interface 415 is also connected to a drive 420 on which a recording medium is mounted. Examples of the recording medium are a magnetic disk 421, an optical disk 422, a magneto-optical disk 423, and a semiconductor memory 424. If necessary, a program read out from the recording medium is installed in the storage section 418.

As explained above, the series of processes carried out by the communication apparatus 1 as described previously can be carried out by hardware and/or execution of software. If the series of processes described above is carried out by execution of software, programs composing the software can be installed into a computer embedded in dedicated hardware, a general-purpose personal computer, or the like from typically a network or the recording medium described above. By installing a variety of programs into the general-purpose personal computer, the personal computer is capable of carrying out a variety of functions.

As explained above, if necessary, a program read out from the recording medium as the software mentioned above is installed in the storage section 418. The recording medium itself is distributed to users separately from the main unit of the communication apparatus 1. As shown in FIG. 13, examples of the recording medium also referred to as package media are magnetic disks 421 including a flexible disk, optical disks 422 including a CD-ROM (Compact Disk-Read Only Memory) and a DVD (Digital Versatile Disk), magneto-optical disks 423 including an MD (Mini Disk [trademark]) and a semiconductor memory 424. As an alternative to installation of a program from the package media into the storage section 418, the program can also be stored in advance typically in the ROM 412 or a hard disk embedded in the storage section 418.

It is worth noting that, in this specification, steps of any program represented by a flowchart described above can be carried out not only in a pre-prescribed order along the time axis, but also concurrently or individually.

It is also to be noted that the technical term ‘system’ used in this specification implies the configuration including a plurality of apparatus.

In addition, it should be understood by those skilled in the art that various modifications, combinations, sub-combinations, and alterations may occur in dependence on design requirements and other factors insofar as they are within the scope of the appended claims or the equivalents thereof.

What is claimed is:

1. An information-processing apparatus for communicating with an other information-processing apparatus, which is connected to said information-processing apparatus through a network, said information-processing apparatus comprising:
reproduction means for reproducing content data common to said information-processing apparatus and said other information-processing apparatus synchronously with said other information-processing apparatus;
user-information receiver means for receiving a voice and image of an other user from said other information-processing apparatus;
synthesis means for synthesizing a voice and image of said content data synchronously reproduced by said reproduction means with a voice and image received by said user-information receiver means as said voice and image of said other user;
characteristic analysis means for analyzing at least one of a voice of said content data synchronously reproduced by said reproduction means, an image of said content data, and auxiliary information added to said content data in order to recognize a characteristic of said content data; and
parameter-setting means for setting a control parameter to be used for controlling a process, which is carried out by said synthesis means to synthesize voices and images, on the basis of an analysis result produced by said characteristic analysis means.

2. The information-processing apparatus according to claim 1, wherein
said characteristic analysis means carries out said analysis in order to recognize a characteristic of a scene included in content data and
said parameter-setting means sets a control parameter to be used for controlling a process, which is carried out by said synthesis means to synthesize voices and images, on the basis of said scene characteristic recognized as an analysis result produced by said characteristic analysis means.

3. The information-processing apparatus according to claim 1, wherein
said characteristic analysis means carries out said analysis in order to recognize the position of character information on an image included in content data as a characteristic of said image
and said parameter-setting means sets a control parameter to be used for controlling a process, which is carried out by said synthesis means to synthesize voices and images, on the basis of said position of said character information on said image as an analysis result produced by said characteristic analysis means.

4. The information-processing apparatus according to claim 1, wherein
said parameter-setting means sets a control parameter of said other information-processing apparatus on the basis of an analysis result carried out by said characteristic analysis means, and
sender means is further provided for transmitting said control parameter set by said parameter-setting means to said other information-processing apparatus.

5. An information-processing method adopted by an information-processing apparatus a method for communicating with an other information-processing apparatus, which is connected to said information-processing apparatus through a network, said information-processing method comprising the steps of:
reproducing content data common to said information-processing apparatus and said other information-processing apparatus synchronously with said other information-processing apparatus;
receiving a voice and image of an other user from said other information-processing apparatus;
synthesizing a voice and image of said content data synchronously reproduced in a process carried out at said reproduction step with a voice and image received in a process carried out at said user-information receiver step as said voice and image of said other user;
analyzing at least one of a voice of said content data synchronously reproduced in a process carried out at said reproduction step, an image of said content data, and auxiliary information added to said content data in order to recognize a characteristic of said content data; and
setting a control parameter to be used for controlling a process, which is carried out at said synthesis step to synthesize voices and images, on the basis of an analysis result produced in a process carried out at said characteristic analysis step.

6. A recording medium for recording a program to be executed by a computer to communicate with an information-processing apparatus, which is connected to said computer by a network, said program comprising the steps of:
reproducing content data common to said computer and said information-processing apparatus synchronously with said information-processing apparatus;
receiving a voice and image of an other user from said information-processing apparatus;
synthesizing a voice and image of said content data synchronously reproduced in a process carried out at said reproduction step with a voice and image received in a process carried out at said user-information receiver step as said voice and image of said other user;
analyzing at least one of a voice of said content data synchronously reproduced in a process carried out at said reproduction step, an image of said content data, and auxiliary information added to said content data in order to recognize a characteristic of said content data; and
setting a control parameter to be used for controlling a process, which is carried out at said synthesis step to synthesize voices and images, on the basis of an analysis result produced in a process carried out at said characteristic analysis step.

7. A program to be executed by a computer to communicate with an information-processing apparatus, which is connected to said computer through a network, said program comprising the steps of:
reproducing content data common to said computer and said information-processing apparatus synchronously with said information-processing apparatus;
receiving a voice and image of an other user from said information-processing apparatus;
synthesizing a voice and image of said content data synchronously reproduced in a process carried out at said reproduction step with a voice and image received in a process carried out at said user-information receiver step as said voice and image of said other user;
analyzing at least one of a voice of said content data synchronously reproduced in a process carried out at said reproduction step, an image of said content data, and auxiliary information added to said content data in order to recognize a characteristic of said content data; and
setting a control parameter to be used for controlling a process, which is carried out at said synthesis step to synthesize voices and images, on the basis of an analysis result produced in a process carried out at said characteristic analysis step.

8. An information-processing apparatus for communicating with an other information-processing apparatus, which is connected to said information-processing apparatus through said network, said information-processing apparatus comprising:
a reproduction section for reproducing content data common to said information-processing apparatus and said other information-processing apparatus synchronously with said other information-processing apparatus;
a user-information receiver section for receiving a voice and image of an other user from said other information-processing apparatus;
a synthesis section for synthesizing a voice and image of said content data synchronously reproduced by said reproduction section with a voice and image received by said user-information receiver section as said voice and image of said other user;
an characteristic analysis section for analyzing at least one of a voice of said content data synchronously reproduced by said reproduction section, an image of said content data, and auxiliary information added to said content data in order to recognize a characteristic of said content data; and
a parameter-setting section for setting a control parameter to be used for controlling a process, which is carried out by said synthesis section to synthesize voices and images, on the basis of an analysis result produced by said characteristic analysis section.
